(19) United States
(12) Patent Application Publication
(10) Pub. No.: US 2003/0182394 A1
(43) Pub. Date: Sep. 25, 2003

(54) Method and system for providing context awareness

(76) Inventors: Oren Ryngler, Columbia, MD (US); Ronny Ron Agam, San Francisco, CA (US); Michael Joseph Gaffney, Perry Hall, MD (US); Dinesh Harischandra Bhat, Sterling, VA (US); Yuval Sinai Boger, Baltimore, MD (US); William Russell Fiste, Columbia, MD (US)

Correspondence Address: Supervisor, Patent Prosecution Services, PIPER RUDNICK LLP, 1200 Nineteenth Street, N.W., Washington, DC, 20036-2412, US

(21) Appl. No.: 10/163,304

(22) Filed: Jun. 7, 2002

Related U.S. Application Data
(60) Provisional application No. 60/296,650, filed on Jun. 7, 2001.
(60) Provisional application No. 60/300,457, filed on Jun. 26, 2001.
(60) Provisional application No. 60/300,458, filed on Jun. 26, 2001.

(51) Int. Cl. G06F 15/16

(52) U.S. Cl. 709/217

(57) ABSTRACT

A method and system for providing context information, systems, and actions for a range of information technology platforms and interfaces. Context includes the aggregate knowledge about a user's situation and intent. Included in the system are tiers of features for enabling context awareness, including a collection tier, analysis tier, and action/effect tier. Information relating to entities, which are the elements that are included in the system, such as users and communication devices, along with states and relationships, is identified and accessed by a context engine, which obtains the information from sensors and interpreters for the information. In one application tier, the context engine is used with any set of entities, states, and relationships. Another application tier, referred to as “context packs,” includes preset sets of entities, states, and relationships identified for predetermined applications.

This application claims priority from U.S. Provisional Application Serial No. 60/296,650 filed Jun. 7, 2001, Serial No. 60/300,457 filed Jun. 26, 2001, and Serial No. 60/300,458 filed Jun. 26, 2001. The entirety of each of these provisional patent applications is incorporated herein by reference.

### BACKGROUND OF THE INVENTION

1. Field of the Invention

The present invention relates to methods and systems for providing context aware information, and in particular to methods and systems for determining use, intent, and situation specific information about users and any other entity, such as devices on networks usable, among other purposes, to optimize the effectiveness of applications and interfaces based on the context information obtained.

2. Background of the Technology

The introduction of mobile data networks has enabled the use of applications even when not in the office, such as when at home or in any other stable environment (e.g., the typical office, chair, telephone, and screen environment, which is readily predictable). However, the mobile user is not able to control an ever-changing environment; movement, device and network resources, and the setting (e.g., car, customer site, meeting room), among other factors, affect the user, while the application maintains its preordained behavior at the time of initial development, typically without incorporating or addressing these effects.

As a result of the ever-changing environment of many situations, the user can face an ordeal when interacting with mobile applications via the mobile device (e.g., size of device, limited input methods). This ordeal manifests itself in the usability of so-called mobile applications; the amount of interaction the user is required to go through produces an acute problem, resulting, in many cases, in the abandonment of the mobile applications by the user.

Today, many applications are available for personal and business use. As computing platforms and Internet use increasingly become commonplace, the productivity of application users is on the rise. However, as discussed above, little has changed in how applications are developed and presented to the user. A developer, usually according to a specification, writes the application, tests are performed, and the application is made available for the user.

Once the application has left the desk of the developer and has been tested, it does not modify its behavior as presented to the user. While the user encounters different situations and schedule changes throughout the day, the application is oblivious to these adjustments, and continues to present information in an unchanging manner. This non-flexible application behavior, while minimizing the efforts required of the application developer, has increased the degree of effort required of the user, in terms of usability.

In this light, it is useful to consider the “context” of an application. Context can be defined as the aggregate knowledge about the Users' situation and intent. There is an unmet need for software applications to optimize the effectiveness of the application in view of context. Examples for such knowledge include the following: 1) Where is the user? 2) What is the user activity? 3) Who is nearby? 4) What is nearby? 5) What devices is the user using? 6) With whom is the user talking? 7) Where is the user going to be? and 8) What the user is going to do?

Some limited manifestations of context exist in the prior art. Although they are simple and rather constant, changes to an application are possible in view of the person that is using the application. One example is personalization engines available in some e-commerce sites. In search of better understanding of the target user for these applications, such personalization engines typically seek limited information about the user. These can be accumulated across several interactions the user has made with the engine.

To determine the situation and intent of the user, there remains an unmet need for methods and systems that collect information about the user, such as the user's location, the user's role, the user's responsibilities, the user's calendar, the presence of the user, the user's device, the situation of, for example, the user's peers, and the user's preferences.

As is apparent, there is thus a further, more general need for a user-centric approach to application development: an approach is needed that incorporates the aggregate knowledge of the users' situation and intent, for which a software application could then optimize the effectiveness of the application. Such an approach would, among other advantages, enable the system to maximize the results to fit with each user's preferences and needs. The usage of context could vary. Context could be used to present the user with relevant information based on the current context situation; it could also be used, for example, to choose the preferred method for communicating with the user.

The major problems preventing developers in the prior art from making context aware applications readily available include the following:

1) Sensors needed for such methods and systems typically involve one or more complex systems, distributed over a variety of physical and logical domains. Sensors generally are not constant in their existence; they may be unavailable or become intermittently available. Sensors present and access data in proprietary ways. For example, after developing access to a sensor for a location finding service, the developer typically cannot re-use it for another system with a different location finding service.

2) Modifying applications according to sensory information would be complex, if possible at all. Developers would be required to build complex analysis into the application in order to use the sensory information. This analysis has no re-use, as it is performed per application. For example, longitude and latitude parameters do not allow the developer to determine if the user is at the office or at a customer site; only after analysis can this information be determined.

3) Modifying the application to match the user's requirements would entail an intricate task. While the analysis could be expected to discover much about the user's activity, actual application behavior would not be expected to be simple to deduce. For example, some users may need sales information after a meeting with a customer, while others require technical data.

In the prior art, there have been several methods and systems that have considered the issue of context, but only in a cursory manner.

For example, U.S. Pat. No. 5,642,303 to Small, et al. discloses a beacon based system for use particularly with specific personal digital assistants (PDAs), such as the Apple® Newton®. Beacons and a sensor attached to the PDA determine the user location, and, when information, such as event locations, is linked to particular information, this information may be provided to the user in a useful manner.

U.S. Pat. No. 6,177,905 B1 to Welch provides a location-triggered reminder method and system for PDA users. With the invention of Welch, the user is able to associate reminders with particular locations, and, with location sensitive input, such as global positioning system (GPS) location information linked to the input, a reminder or other information is generatable for the user upon reaching each particular location.

U.S. Pat. No. 5,664,133 to Malamud et al. provides a computer resource context information provider. The system facilitates control of resources, such as printers and servers, by providing context sensitive pop up menus for each resource. The menus vary by the resource specific environment.

U.S. Pat. No. 5,910,799 to Carpenter, et al., discloses a location motion sensitive user interface. The device of Carpenter, et al., includes an interface environment that provides and/or prevents access to applications based on the location of the user (e.g., prevents user access in unsecured locations). As the user moves, the interface changes.

Pending U.S. patent application Ser. No. 09/825,159 to Abbott, et al., includes disclosure of methods and devices for modeling and using themes and theme-related information, representing various types of contextual aspects or situations, including a wearable computer and inputting and sensing devices used to determine the user state, the user's computing device, the surrounding physical environment, and/or the current cyber-environment.

However, none of the prior art discloses or suggests a broadly applicable interface that is dynamically context sensitive based on a wide variety of user needs and multiple context inputs. There remains an unmet need to provide applications aware of the contextual setting of the user (Context Aware Applications), and methods and systems for implementing and using such applications.

2. Related Art

U.S. Pat. No. 5,470,233 to Fruchterman, et al.

U.S. Pat. No. 5,570,100 to Grube, et al.

U.S. Pat. No. 5,642,303 to Small, et al.

U.S. Pat. No. 5,664,133 to Malamud, et al.

U.S. Pat. No. 5,699,244 to Clark, Jr., et al.

U.S. Pat. No. 5,732,074 to Spaur, et al.

U.S. Pat. No. 5,790,974 to Tognazzini

U.S. Pat. No. 5,910,799 to Carpenter, et al.

U.S. Pat. No. 5,938,721 to Dussell, et al.

U.S. Pat. No. 6,040,781 to Murray

U.S. Pat. No. 6,052,563 to Macko

U.S. Pat. No. 6,078,314 to Ahn

U.S. Pat. No. 6,085,148 to Jamison, et al.

U.S. Pat. No. 6,133,853 to Obradovich, et al.

U.S. Pat. No. 6,148,261 to Obradovich et al.

U.S. Pat. No. 6,163,274 to Lindgren

U.S. Pat. No. 6,177,905 to Welch

### SUMMARY OF THE INVENTION

The present invention includes a method and system for providing context information, systems, and actions for a wide range of information technology platforms and interfaces. In embodiments of the present invention, “context” includes the aggregate knowledge about a user's situation and intent, which a software application or other method and/or system can apply, among other factors, to optimize the effectiveness of the application. Sources of information for determining Context include static sources, such as user roles, user responsibilities, and user preferences, as well as dynamic sources, such as the user's location, user's direction of travel, device being used, calendar, the user's presence or absence at a location, the user's flight or other travel information, the application being used, the network involved, and other impacts on the user, such as determinable impacts on the user's location and direction of travel, such as traffic and weather.

Context is one essential factor in improving computing in general, and mobile computing in particular. Understanding the Context of the user—business and personal—facilitates the creation and deployment of intelligent mobile applications that are more effective, efficient, and easier to use. The Context information is usable to optimize both the information content and its presentation to the user in a manner that reduces the complexity of the human-machine interaction, while increasing information processing capabilities.

One advantage of the present invention is that it provides application developers with a development and runtime environment that enables applications to take into account changes in the settings the user is experiencing. This results in more streamlined applications, with minimal required user interaction, increasing the usability and the user-adoption of applications in general, and mobile applications in particular. These applications are herein referred to as “context-aware applications.”

An embodiment of the present invention includes tiers of features for enabling Context awareness. In an embodiment of the present invention, the tiers include a collection tier, an analysis tier, and an action/effect tier.

The Context Collection Tier provides the developer with simple access to Context Parameters (Context raw data) by way of sensors. In an embodiment of the present invention, this tier masks the complexity of collecting Context Parameters and using sensors, incorporating data availability and how the data are accessed. Furthermore, new Context Sensors can be created and re-used, as long as they conform to the defined interface. In one embodiment, two core tasks are included for the Collection Tier: 1) interfacing and collecting information from various sources and services (e.g., the User's device); and 2) providing some extent of intelligence, by mediating between various context sources. In an embodiment of the present invention, this tier provides a uniform method for accessing Context Parameters within the Architecture, as well as outside of the Architecture.

The Context Analysis Tier provides the developer with Context States—meaningful information about the environment the user is experiencing. One objective of this tier is to “mirror” the settings and environment of the user, including applications applicable to or accessible by the user, in an analytical way and make information thereby produced or determined available for applications. An example Analysis Tier task is combining several context values to generate a more powerful understanding of the current situation. For instance, knowing the current location and current time, together with the user's calendar, the application is able to determine the user's current social situation, such as having a meeting, sitting in a class, or waiting in the airport. In an embodiment of the present invention, this tier provides a uniform method for accessing Context States within the Architecture, as well as outside of the Architecture.

The Context Actions/Effects Tier merges context states, user preferences, and application content to derive the objective and/or inferentially or otherwise determine the intent of the user, resulting in actions that modify the application. Actions are then applied, for example, to the presentation, navigation, or the application logic of an existing application, or even the launch of an external application. In an embodiment of the present invention, this tier provides a uniform method for accessing Context Actions/Effects within the Architecture, as well as outside of the Architecture.

In operation, in order to provide context information and services, as well as to perform many other functions, some input data is required and the overall context-related environment needs to be modeled. For example, for a user, the user's name, address, and other personal information is useful. In addition, the relationships between a user and other aspects of their environment, such as what meetings they are scheduled to attend or who is currently with them, is also valuable in determining a particular user's situation and intent. In one embodiment of the present invention, the input data and the various relationships are provided to a “context engine” for processing. Since information relating to a user and the user's environment may reside in various sources (e.g., databases, airline reservation system, scheduling system), each component of hardware and/or software required to obtain the necessary information is located and placed in direct contact with the context engine or via other hardware or software components linked to the context engine. Each person, place, or thing that is determined to be useful in deriving contextual information is modeled within the current invention to form a network of components, each of which is referred to herein as an “entity.” Entities include, for example, the user, each of the user's devices, any network with which the user is interfacing, along with many other items maintained within the context engine, such as other hardware components, and other discrete elements, such as each meeting or other event. This information is provided to the Context Engine via, for example, an interface to the network of locations for the information.

In embodiments of the present invention, the provision of information to the context engine is generally referred to as being provided by “sensors.” Sensors include, for example, sensed data, such as location information received from a cellular telephone, as well as collected data, such as data obtained from an accessed database by an interface for the context engine.

Another aspect of the invention that allows interconnection and use of sensor data and other input is referred to as an “interpreter.” An “interpreter” transforms, for example, sensed data into useful information for context. For example, an interpreter may use raw data from a cellular telephone to determine an address location for the cellular telephone, or for the user, if, for example, another interpreter interprets the user as having or likely having the cellular telephone in the user's possession.

Context Modeling

The context engine also maintains information relating to the entities and the relationships among entities, which may be constantly or periodically updated. In an embodiment of the present invention, relationships are referred to as “first class objects” (e.g., these objects are able to have associated features referred to as “states” and “properties”). “States” are provided for and relate to each entity or to a relationship among two or more entities.

For example, each of the following illustrates states of objects:

1) “Tim is busy”—Tim is the entity and busy is a state of Tim;

2) “Tim is scheduled for Flight 1043”—Tim is an entity, Flight 1043 is an entity, and a relationship is created between Tim and the Flight; and

3) “Tim is late for Flight 1043”—Tim is the entity, but the state of “late” is on the relationship between Tim and the Flight, not on the Tim entity.

The following provide a similar example:

1) “Tim has a 1:00 p.m. meeting”;

2) “Tim has a 2:00 p.m. meeting”;

3) Three entities (Tim, 1:00 p.m. meeting, 2:00 p.m. meeting);

4) Two relationships (Tim to 1:00 p.m. meeting, Tim to 2:00 p.m. meeting); and

5) “Tim is late for the 1:00 p.m. meeting”—the relationship between Tim and the 1:00 p.m. meeting has the state of “late,” not the Tim entity or the 1:00 p.m. meeting entity, because Tim is not late for the 2:00 p.m. meeting, and the 1:00 p.m. meeting is on time.

As exemplified above, three types of “relationships” exist in the context engine in an embodiment of the present invention. These relationships include the following: 1) the relationship of each entity to a state (e.g., Tim is busy); 2) the relationship that may exist between the two entities (e.g., Tim is scheduled for Flight 1043); and 3) the relationship of a state to the relationship between two entities (e.g., Tim is late for Flight 1043).

For the context engine to maintain and provide information or other services or actions relating to each of these components, a large amount of information relating to entities, states, and relationships must be identified and be accessible for the context engine. In an embodiment of the present invention, some state information is obtained via interfacing software connected to each component in the system, and the state and relationship parameters are used by this interfacing software or other software that determines state and relationship information.

In the broadest application, the context engine of the present invention allows use of any set of entities, states, and relationships that may be input. The context engine is thus a raw engine (something like a “blank slate”) for any such input entity, state, and relationship.

Context Packs

Another application of an embodiment of the present invention provides preset groups or sets of entities, states, and relationships (something like a “template”) that are particularly useful for predetermined applications, such as a group of workers in corporate applications. These specific implementations of the present invention are referred to as “context packs.” For example, a context pack may include as entities for input information, along with appropriate states and relationships, the following: users; cellular telephones for the users; office computers for the users; and meetings scheduled on a network for the users. Thus, particular entities, states, and relationships are predefined in context packs. Another feature of each context pack includes particularly defined sensors and interpreters for that pack.

Additional advantages and novel features of the invention are set forth in the attachments to this summary, and in part will become more apparent to those skilled in the art upon examination of the following or upon learning by practice of the invention.

### BRIEF DESCRIPTION OF THE FIGURES

In the drawings:

FIG. 1 provides a representative block diagram of the Context Pack build on top of the Context Engine, in accordance with an embodiment of the present invention;

FIG. 2 illustrates factors and considerations involved in determining a user's need and intent, in accordance with an embodiment of the present invention;

FIG. 3 shows examples of the usage of context information, in accordance with embodiments of the present invention;

FIG. 4 illustrates some of the differences between customization, personalization, and context, as used in accordance with the present invention;

FIG. 5 shows examples of using ‘Static Context’ to determine relevant content and services/actions, in accordance with an embodiment of the present invention;

FIG. 6 presents an example of using ‘dynamic context’ factors and considerations involved therein to determine context and services/actions, in accordance with an embodiment of the present invention;

FIG. 7 is an example representative diagram of how wired and wireless portals can leverage the Context information to determine relevancy, in accordance with an embodiment of the present invention;

FIG. 8 provides a representative block diagram of the general operation of one embodiment of the present invention that produces context information that is usable to determine relevant information;

FIG. 9 presents a representative diagram of the Context Architecture, including three tiers of abstractions to simplify the developers' work in delivering Context Aware Applications, in accordance with an embodiment of the present invention;

FIGS. 10 and 11 present variations of context awareness maps for determining context aware information and producing context aware applications, in accordance with embodiments of the present invention;

FIG. 12 illustrates a representative diagram of how, by applying the various context states, the available information can be filtered into relevant information, in accordance with an embodiment of the present invention;

FIG. 13 presents an example UseCase Diagram of architecturally significant use cases, in accordance with an embodiment of the present invention;

FIG. 14 shows as Class diagram of a domain model, in accordance with an embodiment of the present invention;

FIG. 15 is a Collaboration diagram of an example context state domain model, in accordance with an embodiment of the present invention;

FIG. 16 contains a Class diagram of state hierarchy, in accordance with an embodiment of the present invention;

FIG. 17 is a Collaboration diagram of relationships of services functions, in accordance with an embodiment of the present invention;

FIG. 18 presents a Class diagram of entity service functions, in accordance with an embodiment of the present invention;

FIG. 19 contains a Class diagram of notification service functions, in accordance with an embodiment of the present invention;

FIG. 20 is a Class diagram of event hierarchy structure, in accordance with an embodiment of the present invention;

FIG. 21 presents a Class diagram of a JiniBean model for use in accordance with an embodiment of the present invention;

FIG. 22 contains a Statechart diagram of a JiniBean state model for use in accordance with an embodiment of the present invention;

FIG. 23 is a Class diagram of a SensorBean model for use in accordance with an embodiment of the present invention;

FIG. 24 provides a components diagram of context engine components, in accordance with an embodiment of the present invention;

FIG. 25 provides an Activity diagram for generating an example event for user being late for an appointment, in accordance with an embodiment of the present invention;

FIG. 26 is a flow diagram of the flow of information to and from the Context Pack, in accordance with an embodiment of the present invention;

FIG. 27 shows a representative diagram of how the functionality of various Context Packs can be layered for reuse (e.g., the Workgroup Context Pack utilizes functionality from the Basic Pack) to handle the information about the user, the user's appointments, the user's location, and the appointments location, in accordance with an embodiment of the present invention;

FIG. 28 is a representative diagram of the high level external interfaces to the Context Pack system;

FIG. 29 contains a table of actors involved in the process for the diagram of FIG. 28;

FIG. 30 presents a representative diagram of the overall architectural structure of an embodiment of the present invention;

FIG. 31 shows a representative diagram of the technology for each component in the Context Pack for an embodiment of the present invention;

FIG. 32 is a representative block diagram of an example query service subsystem and its dependencies, in accordance with an embodiment of the present invention;

FIG. 33 provides a table of summary information relating to the query service subsystem, in accordance with an embodiment of the present invention;

FIG. 34 is a representative block diagram of the event service feature of the Context Pack, in accordance with an embodiment of the present invention;

FIG. 35 provides summary information for the ActivitySubscriber feature, in accordance with an embodiment of the present invention;

FIG. 36 contains a representative flow diagram of a method summary for Appointment Subscriber, in accordance with an embodiment of the present invention;

FIG. 37 provides a method summary table for the AvailabilitySubscriber feature, in accordance with an embodiment of the present invention;

FIG. 38 contains a table of field summary information for the TimeProximitySubscriber feature, in accordance with an embodiment of the present invention;

FIG. 39 contains a table of method summary information for the TimeProximitySubscriber feature, in accordance with an embodiment of the present invention;

FIG. 40 contains a representative block diagram of an interpreter subsystem, in accordance with an embodiment of the present invention;

FIG. 41 is a representative block diagram of an infrastructure subsystem, in accordance with an embodiment of the present invention;

FIG. 42 provides a representative block diagram of a sensor subsystem, in accordance with an embodiment of the present invention;

FIG. 43 presents a table of Topics and Queues for the messaging system for an embodiment of the present invention;

FIG. 44 presents a diagram of an example Context model used in a Context Pack, in accordance with an embodiment of the present invention;

FIG. 45 is a representative block diagram of a state model for use in accordance with an embodiment of the present invention;

FIG. 46 contains a flow diagram of an example distance proximity event, in accordance with an embodiment of the present invention;

FIG. 47 presents a flow diagram of an example time proximity event, in accordance with an embodiment of the present invention;

FIG. 48 is a representative ER diagram showing the database schema for an example Context Pack, in accordance with an embodiment of the present invention;

FIG. 49 shows a table of information for use in conjunction with the database schema of FIG. 48;

FIG. 50 is an example user proximity event activity, in accordance with an embodiment of the present invention;

FIG. 51 shows an example group proximity query, in accordance with an embodiment of the present invention;

FIG. 52 contains an example user location updating activity, in accordance with an embodiment of the present invention;

FIG. 53 is an example flow diagram for handling of sensor specified location in the Context Pack, in accordance with an embodiment of the present invention;

FIG. 54 shows an example flow diagram for location handling in the event service, in accordance with an embodiment of the present invention;

FIG. 55 contains an example flow diagram for location handling in the query service, in accordance with an embodiment of the present invention;

FIG. 56 is a representative block diagram of a runtime view, including processes, threads, and remote objects, in accordance with an embodiment of the present invention;

FIG. 57 presents a representative flow diagram of a deployment view, including JVM nodes with distributed objects model, a distributed objects model, and mapping of development jars to deployment jars, in accordance with an embodiment of the present invention; and

FIGS. 58 and 59 present context based information examples for a hand held device, in accordance with an embodiment of the present invention.

### DETAILED DESCRIPTION

The present invention includes a method and system for providing context information, systems, and actions for a wide range of information technology platforms and interfaces.

One advantage of the present invention is that it provides application developers with a development and runtime environment that enables applications to take into account changes in the settings the user is experiencing or the context of other individuals or machines that are relevant to them. With regard to machines, for example, the present invention is able to provide context information to other software programs, such as a portal display, and to provide context information to other machines, such as by providing an alarm system that automatically turns itself off when nobody is detected in a building after a certain hour. Another example is room thermostats that automatically adjust, depending on the number of people in the room or who is in the room (e.g., a baby). Thus, the present invention is also usable to optimize situations for users or machines.

These features of the present invention also result in more streamlined applications, with minimal required user interaction, increasing the usability and the user-adoption of applications in general, and mobile applications in particular. These applications are herein referred to as “context-aware applications.”

The present invention may be best understood by considering an illustrative example application, and by then considering various components of the present invention utilized to meet the features of the illustrated example.

In the illustrative example application, contextually appropriate information is to be provided to a user who has, for example, a hand-held device, such as a personal digital assistant (PDA), a cellular telephone, and a desktop PC located at the user's home, each of which is associated with the user. Among other functions, the present invention provides methods and systems for continually or intermittently transmitting information to and about the user in a manner consistent with the context of the information provided and the medium by which it is provided. For example, the present invention may remind the user via the user's hand-held device of the approach of a meeting, the reminder being formatted appropriately for the hand-held device, while a similar reminder provided to the user at the home computer is formatted quite differently. The present invention may also automatically provide the user with directions to the meeting based on the user's location, which is determined, for example, by locating the user via the location of the user's cellular telephone, and by using the location of the meeting, which is determined, for example, via input from a database containing the meeting location. The present invention may also determine the likelihood of the user been late to the meeting, and then inform each of the other meeting participants of the user's status in relation to the meeting (e.g., transmit to other users via their PDA's the fact that the user will be 5 minutes late).

In order to provide this example context-aware information and services, as well as to perform many other functions, information relating to the user, such as the user's name, address, and other personal information, as well as other user specific information, such as information in the user's contacts database, is provided to a “context engine” feature of the present invention. In addition, each component of hardware and/or software relating to the user is located and placed in contact with the context engine or other hardware or software components linked to the context engine. Each element making up the network of components for the invention is referred to as an “entity.” Entities include, for example, the user, each of the user's devices, any network with which the user is interfacing, and other items maintained within the context engine, such as other hardware components, and other discrete elements, such as each meeting or other event. This information is provided to a context engine feature of the present invention, such as by providing an interface via a network to locations for the information (e.g., databases on the user's PC or a connected server).

In embodiments of the present invention, the provision of information to the context engine is generally referred to as occurring via “sensors.” Sensors include, for example, sensed data, such as location information received from a cellular telephone, as well as collected data, such as data obtained from an accessed database by an interface for the context engine. Appendix A illustrates some sensor examples for use in accordance with embodiments of the present invention.

Another aspect of the invention that allows interconnection and use of sensor data and other input is referred to as an “interpreter.” An “interpreter” transforms, for example, sensed data into useful information for context. For example, an interpreter may use raw data from a cellular telephone to determine an address location for the cellular telephone, or for the user, if, for example, another interpreter interprets the user as having or likely having the cellular telephone in the user's possession.

Context Modeling

The context engine also maintains information relating to the entities and the relationships among entities, which may be constantly or periodically updated. In an embodiment of the present invention, relationships are referred to as “first class objects” (e.g., these objects are able to have associated features referred to as “states” and “properties”). “States” are provided for and relate to each entity or to a relationship among two or more entities.

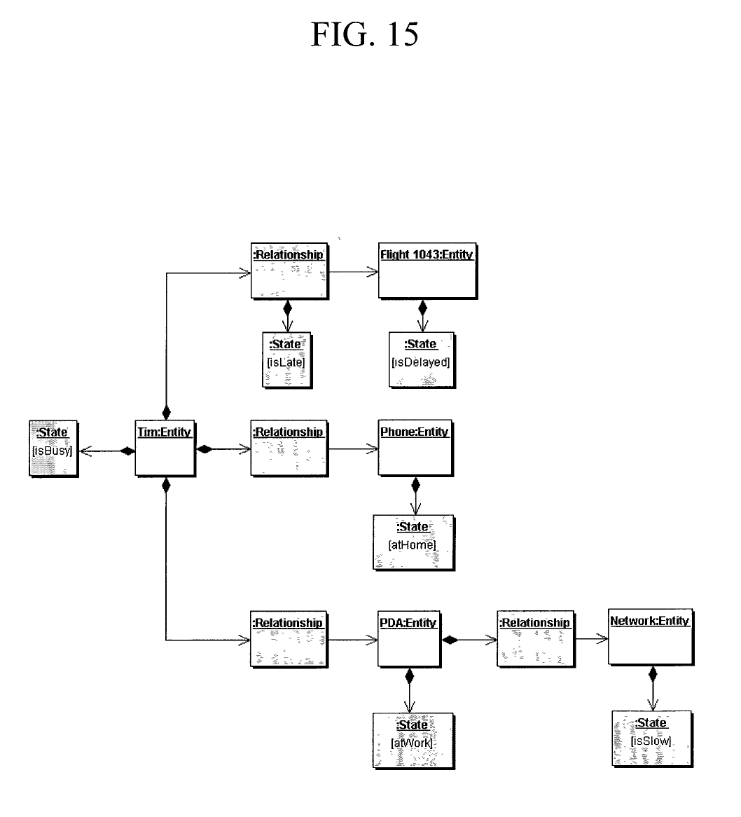

For example, each of the following illustrates states of objects (see also FIG. 15 and accompanying text below):

1) “Tim is busy”—Tim is the entity and busy is a state of Tim;

2) “Tim is scheduled for Flight 1043”—Tim is an entity, Flight 1043 is an entity, and a relationship is created between Tim and the Flight; and

3) “Tim is late for Flight 1043”—Tim is the entity, but the state of “late” is on the relationship between Tim and the Flight, not on the Tim entity.

The following provide a similar example:

1) “Tim has a 1:00 p.m. meeting”;

2) “Tim has a 2:00 p.m. meeting”;

3) Three entities (Tim, 1:00 p.m. meeting, 2:00 p.m. meeting);

4) Two relationships (Tim to 1:00 p.m. meeting, Tim to 2:00 p.m. meeting); and

5) “Tim is late for the 1:00 p.m. meeting”—the relationship between Tim and the 1:00 p.m. meeting has the state of “late,” not the Tim entity or the 1:00 p.m. meeting entity, because Tim is not late for the 2:00 p.m. meeting, and the 1:00 p.m. meeting is on time.

As exemplified above, three types of “relationships” exist in the context engine in an embodiment of the present invention. These relationships include the following: 1) the relationship of each entity to a state (e.g., Tim is busy); 2) the relationship that may exist between the two entities (e.g., Tim is scheduled for Flight 1043); and 3) the relationship of a state to the relationship between two entities (e.g., Tim is late for Flight 1043).

For the context engine to maintain and provide information or other services or actions relating to each of these components, a large amount of information relating to entities, states, and relationships must be identified and be accessible for the context engine. In an embodiment of the present invention, some state information is obtained via interfacing software connected to each component in the system, and the state and relationship parameters are used by this interfacing software or other software that determines state and relationship information.

Context Packs

In the broadest application, the context engine of the present invention allows use of any set of entities, states, and relationships that may be input. The context engine is thus a raw engine (something like a “blank slate”) for any such input entity, state, and relationship.

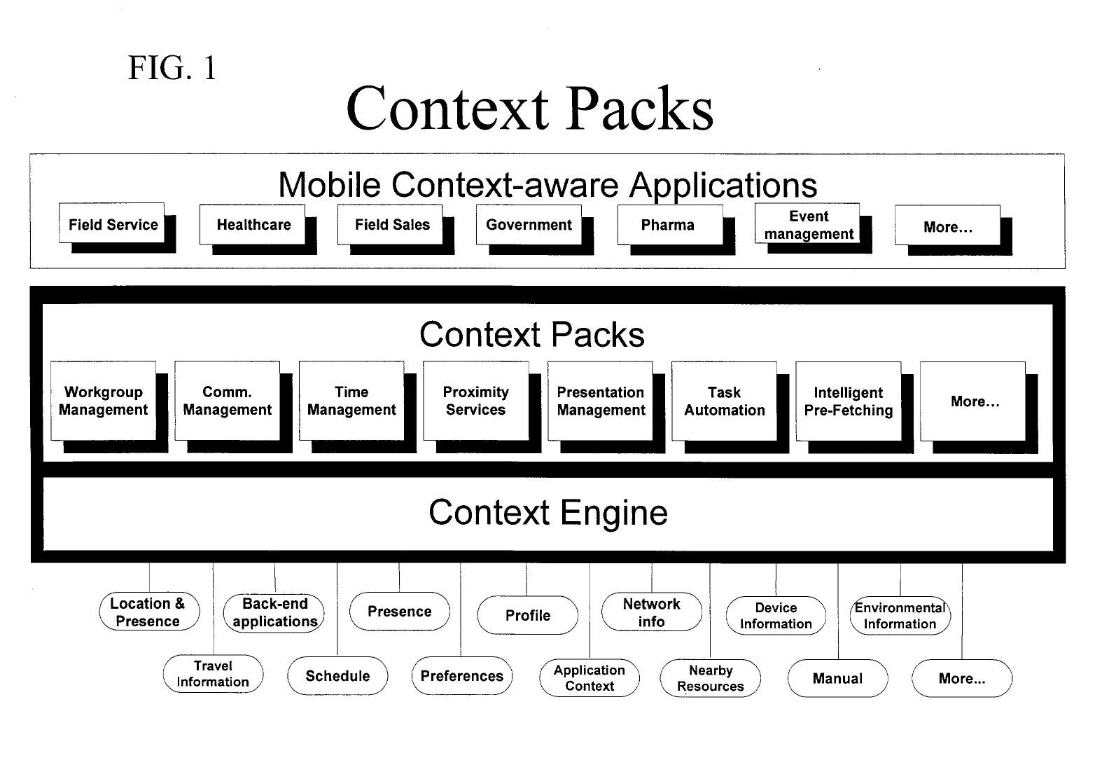

Another application of an embodiment of the present invention, uses preset groups or sets of entities, states, and relationships (something like a “template”) that are particularly useful for predetermined applications, such as a group of workers in corporate applications. These specific implementations of the present invention are referred to as “context packs,” for which an example implementation is described further with respect to FIG. 1. FIG. 1 provides a representative block diagram of the Context Pack build on top of the Context Engine, in accordance with an embodiment of the present invention. As shown in FIG. 1, the Context Packs are usable by various applications to establish context aware applications.

These example Context Packs and their associated description are as follows:

1) Intelligent Synch/Prefetch—at device cradle sync, on demand, and upon detecting return to coverage, selectively sync/pre-fetch information that is relevant based upon the user's schedule, location and activity;

2) Workgroup—provides access to information about peer availability/presence, location, skills, and on-hand inventory;

3) Travel—provides alerts and menu options based upon time, schedule, location, and commercial content services (e.g., flight, traffic, weather);

4) Application—provides context options based on the specific usage of an application by sensing the application (including field specific context) and providing access to relevant menu options (across other applications and services) and triggering new filtering parameters for Alerts;

5) Presentation—optimizes content delivery based on user activity (e.g., driving), location (e.g., customer site), device, and network characteristics;

6) Communications—manages the preferred communication options based on presence, work status and preferences of user;

7) Location/Proximity Services—Identifies physical locations, services, or devices based on user's location, commercial content services (e.g., maps, directions, locator guides), and schedule; and

8) Workflow—provides menu options based on specific alert generation requirements and application (workflow) context.

These example Context Packs may include as entities for input information, along with appropriate states and relationships, the following: users; cellular telephones for the users; office computers for the users; and meetings scheduled on a network for the users. Thus, particular entities, states, and relationships are predefined in context packs for use by the users. Another feature of each context pack includes particularly defined sensors and interpreters for that pack.

Various features of the present invention will now be discussed in greater detail.

A. What is Context?

Context is one essential factor in improving computer applications in general, and mobile applications in particular. Understanding both the context of the user and any other object, such as mobile devices, facilitates the creation and deployment of intelligent mobile applications that are more effective, efficient, and easier to use. The present invention enables applications to use context to optimize both the information content and its presentation to the user in a manner that reduces the complexity of the human-machine interaction, while increasing information processing capabilities.

Before defining context, as used herein, it is important to define in more particularity the concept of “context-aware” applications, as used herein. When one looks at the dictionary definition of context, one generally finds a broad definition, such as the following: 1) the part of a text or statement that surrounds a particular word or passage and determines its meaning; or 2) the circumstances in which an event occurs; a setting.

Some academic definitions are as broad as the dictionary definition: “Context is any information that can be used to characterize the situation of an entity. An entity is a person, place, or object that is considered relevant to the interaction between a user and an application, including the user and application themselves.” See, e.g., Dey, A. K., et al., Toward a Better Understanding of Context and Context-Awareness, (1999), which is hereby incorporated by reference.

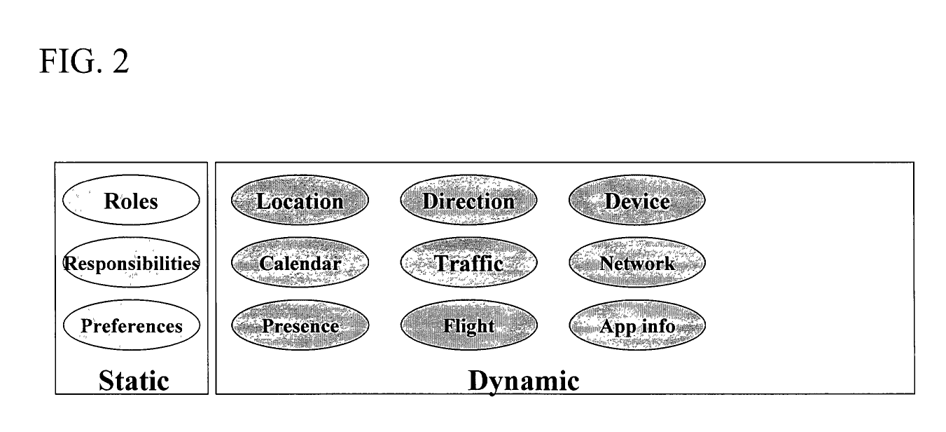

FIG. 2 presents examples of factors relating to context, in accordance with an embodiment of the present invention. These factors include both static factors and dynamic factors. Context, as used herein, can be generally described as the aggregate knowledge about the user's situation and intent, which a software application or other aspect of the method and system of the present invention applies to optimize the effectiveness of the application.

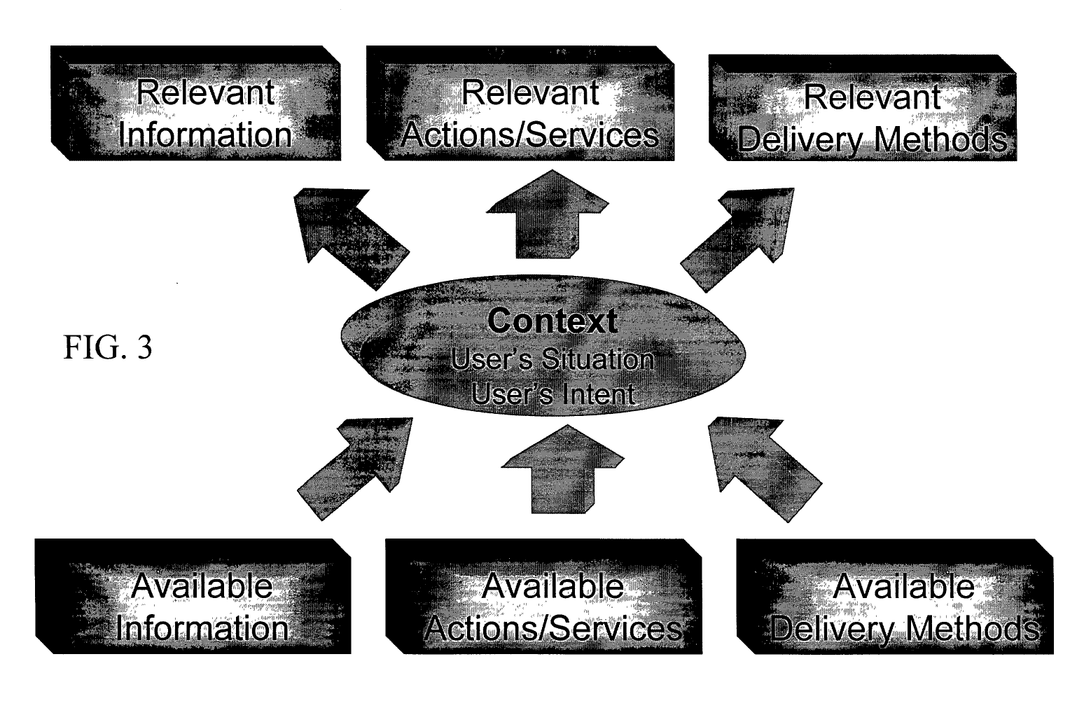

FIG. 3 shows an overview of factors involved in using context for methods and systems, in accordance with embodiments of the present invention. As indicated, context can be applied, among other factors, to determine relevant information, relevant actions/services, and relevant methods of delivery.

In addition, simpler manifestations of context exist: Customization and Personalization. In the case of Customization, the user is able to specify presentation preferences according to specific interests. In the case of Personalization, the application changes its behavior based on the user attributes, usage habits, and personal preferences.

While Personalization and Customization are common in many web applications in the prior art, a more detailed discussion of their place within Context, in accordance with the present invention, is appropriate to a full understanding of the present invention. Customization occurs when the user provides explicit information to the application, prior to application launch. This general application of Customization falls within a well-explored domain, in which Customization is recognized as an important ingredient in web applications. Personalization is a more complex entity that includes both explicit and implicit information regarding the user, usually on an on-going basis (e.g., accumulating historical user data). Personalization is targeted at learning more about an anonymous user (e.g., in e-commerce) in search of relevant information. In most cases, the first interaction with the user occurs with complete ignorance of the personalization engine. As more user interactions take place, the personalization engine modifies the information sent to the user. This information can be stored for future interactions.

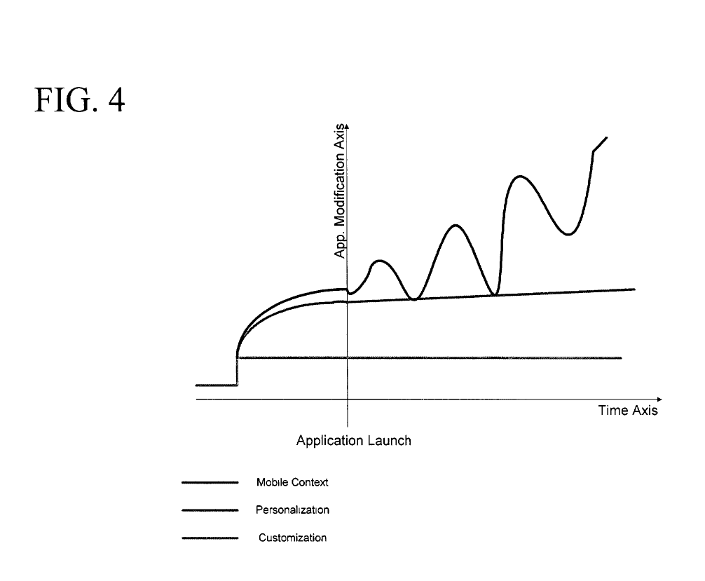

FIG. 4 illustrates some of the differences between customization, personalization, and context, as used in accordance with the present invention. The X Axis represents time, and the application-launch marks the time the user starts the application. The Y Axis represents the modifications the application makes in view of new context information (e.g., customization, personalization, and mobile context). Note that, in the case of context, the application is actually in constant change, adapting itself after the application was launched. In regard to customization and personalization, the application is relatively constant once launched. Another way to look at this is to consider an application that has been tailored to a particular user—this tailoring (customization and personalization) can be performed off-line before the application is launched. Imagine, as an example, the John Doe Sales Force Automation: customization and personalization would include an application that is tailored to John Doe, including his personal preferences and details. However, because it does not include context, this example application is not be able to consider changes in John Doe's environment, as these changes are not constant.

Personalization and customization are part of the context aware application concept; however, the context concept is wider and contains, in addition to the explicit and implicit information determined by the system as Customization and Personalization, information about the user's environment, such as the location of the user, the location of co-workers, the device type used, and the network bandwidth available.

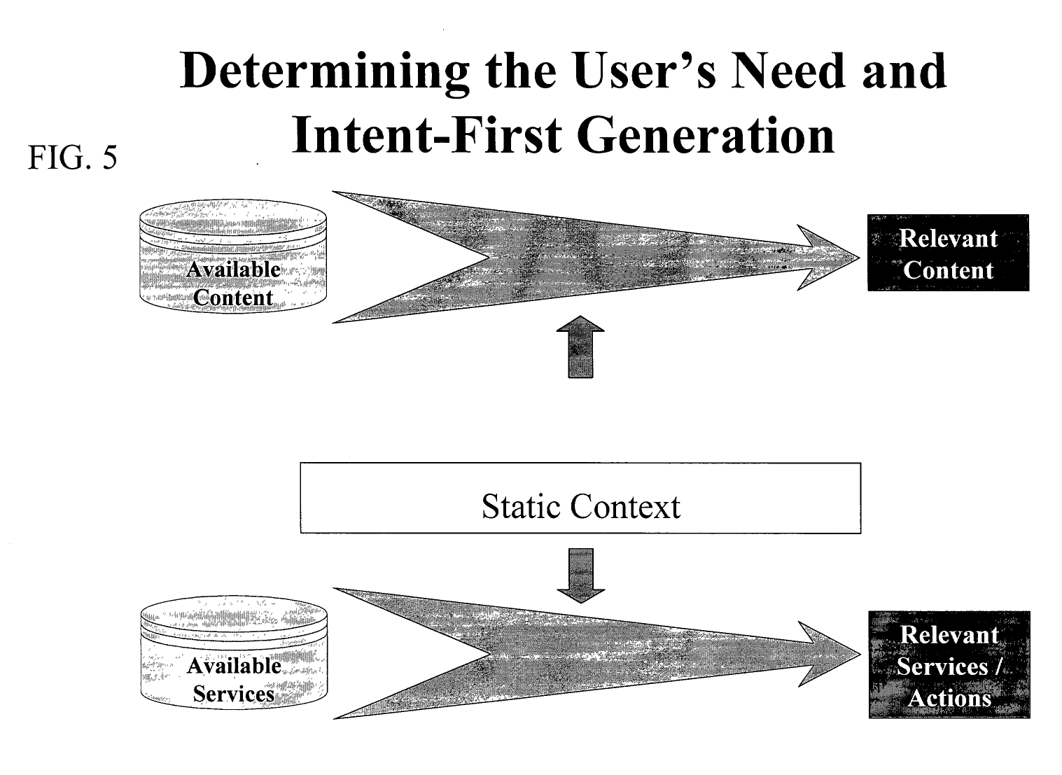

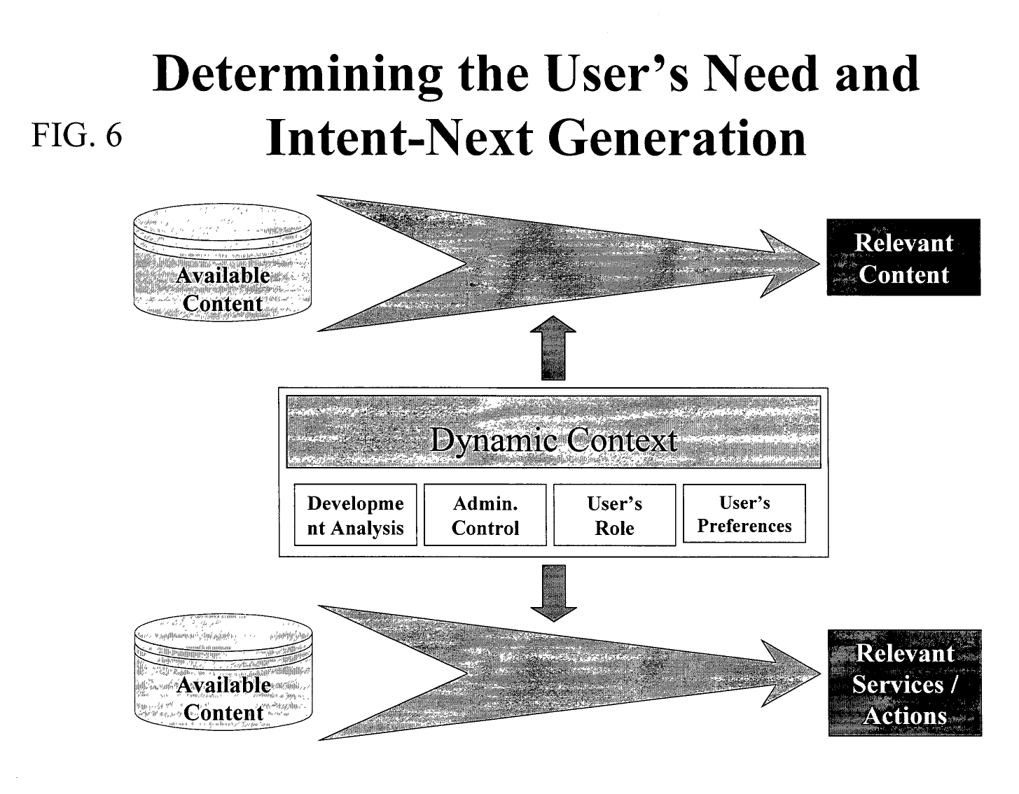

As indicated above, FIG. 2 illustrates factors and considerations involved in determining a user's context, in accordance with an embodiment of the present invention. FIG. 5 shows examples of using ‘Static Context’ to determine relevant content and services/actions, in accordance with an embodiment of the present invention. The user's dynamic context can be applied to determine relevancy, as described in FIG. 6.

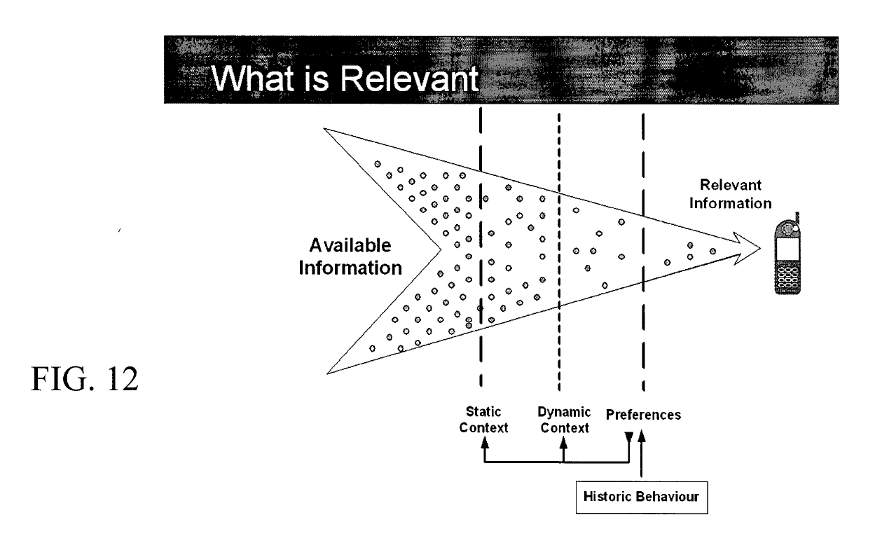

Applications that use dynamic Context sources in addition static Context and user's preferences, increase significantly the ability to infer the user's need and intent, thereby allowing increase in the accuracy of relevancy. (See also FIG. 12 and accompanying text, below).

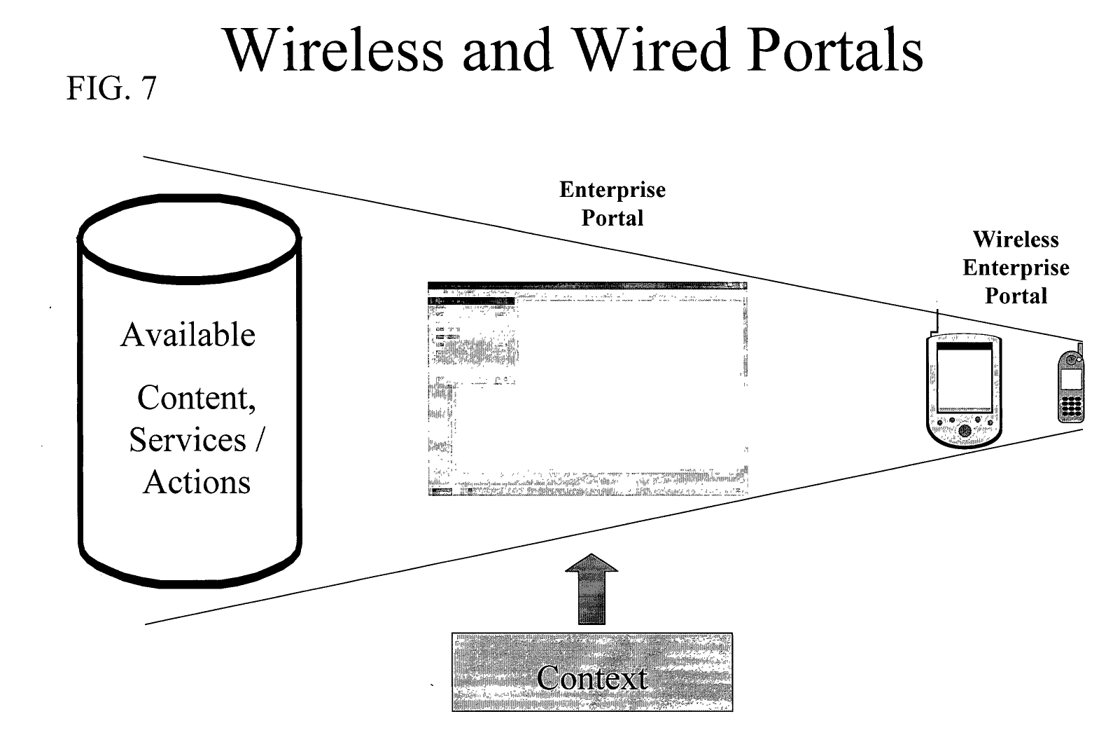

FIG. 7 is an example representative diagram of how portals can leverage Context information to better determine relevancy. As shown in FIG. 7, from available content and services/actions, an enterprise portal (as described further below), using application of context, can provide, for example, more relevant information, and the same is true for a wireless portal, such as a hand-held device (e.g., PDA or wireless telephone). Where the importance of presenting only the most relevant information is critical, the provision of more relevant information can be achieved by applying the user's context, as described in accordance with the present invention.

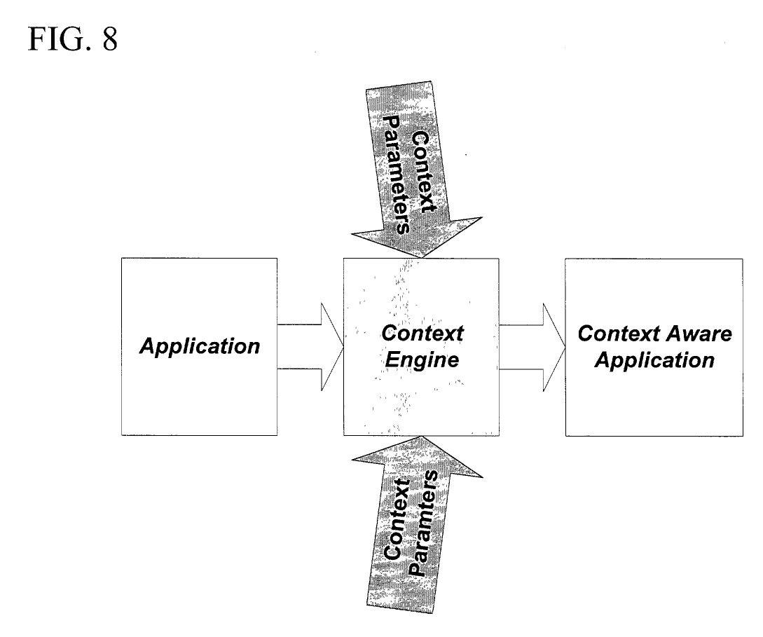

FIG. 8 provides a representative block diagram of the general operation of one embodiment of the present invention that produces relevant information that can be used by other applications to present, for example, relevant information and services.

Complexities Involved in Developing Context-Aware Applications

Developing Context Aware Applications is not an easy task. While the benefit is clear, the technology that supports context awareness and the complexity of the environment causes Context Aware Application development to be complex and cumbersome. In addition, no current architecture supports the reuse of complex applications from one environment to another. This has caused Context Aware Applications to be tailored to specific needs and environments.

Specifically, Context Awareness relies on the ability of Context Sensors to collect user and environment data (i.e., Context Parameters). The highly complex process of Context Awareness has no well-defined interface to access the Context Parameters or the Sensors, and as a result exposes the developer to the high complexity of gathering this information.

The complexity does not end there; sensors tend to produce a large amount of data, frequently requiring further analysis to reveal the user's environment and actions. Again, this complexity is not masked from the developer, who must analyze the data and turn it into useful information.

Context Aware Applications are able to modify their behavior according to the information derived by sensors and the analysis. This is also not a simple task—knowing what the user is doing and understanding the experienced environment does not always easily translate into an effect that modifies the behavior of the application.

To summarize, three major problems prevent developers from making Context Aware Applications readily available:

1) Sensors are a complex system, distributed over physical and logical domains. Sensors are not constant in their existence; they may be unavailable or become intermittently available. Sensors present and access data in a proprietary way. For example, after developing access to a sensor for a location finding service, the developer cannot re-use it for another system with a different location finding service.

2) Modifying applications according to sensory information is complex, if possible at all. Developers must build complex analysis into the application in order to use the Sensory information. This analysis has no re-use as it is performed per application. For example, longitude and latitude parameters do not allow the developer to know if the user is at the office or at a customer site; only after analysis can this be achieved.

3) Modifying the application to match the user's requirements is an intricate task. While the analysis discovers much about the user's activity, actual application behavior is not simple to deduce. For example, some users may need sales information after a meeting with a customer while others require technical data.

The present invention addresses the above complexities by presenting a process and architecture for the development of a context aware system.

B. Process for Producing Context Aware Application

In accordance with these parameters, a general overview of a process for producing a context aware application will now be described, in accordance with embodiments of the present invention. In order to present a user's context (or entity's context), information must be gathered about the user's environment and activities. This information is distributed and cuts across many constituents (e.g., location, weather, traffic, network bandwidth). Analysis is made of the collected information in order to deduce a credible representation of the user's context (e.g., activity and environment). Actions are then applied to the application. These actions are designed to be in line with the user's intent—to create the total effect of easier and more accurate use of the application.

One feature of the present invention provides developers with a development and runtime environment that enables the application to recognize changes in the user's context. This feature results in more streamlined applications, with minimal required user interaction, which increases the usability and the user-adoption of applications.

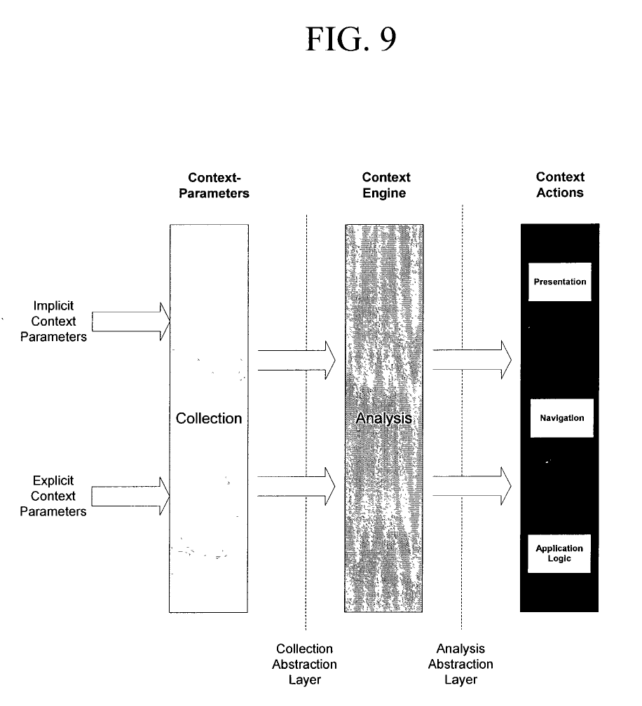

Context Architecture. As discussed in greater detail below with regard to Context Engine Architecture below, the Context Architecture of the present invention provides developers with a complete set of services, enabling the development and deployment of context aware applications. The Architecture masks the complexity required to deliver context aware applications by providing context abstraction layers to the application developers. In embodiments of the present invention, as shown in FIG. 9, the Context Architecture includes three tiers of abstractions to simplify the developers' work in delivering Context Aware Applications. This enables more rapid context aware application development and delivery of re-usable context aware application components.

While the underlying architecture of the present invention provides a very flexible structure to support many of the requirements of Context Aware Applications, most developers should be relieved from comprehending and developing according to that underlying architecture. The Context development paradigm of the present invention adopts the notion of supporting the division of labor between various types of developers.

As shown in FIG. 9, the three tiers utilized in accordance with embodiments of the present invention include the following.

The Context Collection Tier, in an embodiment of the present invention, provides the developer with simple access to Context Parameters by way of sensors. In an embodiment of the present invention, this tier masks the complexity of collecting Context Parameters and using sensors, incorporating data availability and how the data are accessed. Furthermore, new Context Sensors can be created and re-used, as long as they conform to the defined interface. In one embodiment, two core tasks are included for the Collection Tier: 1) interfacing and collecting information from various sources and services (e.g., for use by the User's device); and 2) providing some extent of intelligence, by mediating between various context sources. In an embodiment of the present invention, this tier provides a uniform method for accessing Context Parameters within the Architecture, as well as outside of the Architecture.

The Context Analysis Tier, in an embodiment of the present invention, provides the developer with Context States—meaningful information about the environment the user is experiencing. One objective of this tier is to “mirror” the settings and environment of the user in an analytical way and make it available for applications. An example Analysis Tier task is combining several context values to generate a more powerful understanding of the current situation. For instance, knowing the current location and current time, together with the user's calendar, the application is able to determine the user's current social situation, such as having a meeting, sitting in a class, or waiting in the airport. In an embodiment of the present invention, this tier provides a uniform method for accessing Context States within the Architecture, as well as outside of the Architecture.

The Context Actions/Effects Tier, in an embodiment of the present invention, merges context states, user preferences, and application content to derive the objective of the user, resulting in actions that modify the application. Actions are then applied, for example, to the presentation, navigation, or the application logic of an existing application or even the launch of an external application. In an embodiment of the present invention, this tier provides a uniform method for accessing Context Actions/Effects within the Architecture, as well as outside of the Architecture.

Various other aspects of the features of context interpretation and analysis, which are designed to address these complex issues, in accordance with an embodiment of the present invention, will now be discussed in greater detail.

Mediation—In embodiments of the present invention, Context is sensed from different sensors, which may conflict with each other. For example, location can be sensed from several different sensors, such as the following: a geographical positioning system (GPS), Schedule (location of user's meeting), telephone carrier, and others (e.g., manual, the user using a desktop may allow deduction of the user's location—home, office). Logical features of the present invention, referred to in one embodiment as “Interpreters,” are used with embodiments of the present invention to determine what is the highest probability for the ‘User Location State’ by, for example, analyzing the various location-related context sources.

Abstraction—In embodiments of the present invention, high-level states are determined from low-level parameters, usually by probing different sensory information and/or other information and determining high-level states by applying certain logic. For example, a high-level Context State can be ‘User's Activity,’ which is deduced by analyzing low-level parameters, such as Schedule, Location, and Presence.

Prediction—This feature, in accordance with embodiments of the present invention, predicts the User's ‘Future Context.’ The system of the present invention attempts to determine what the User's (or other Entity's) Context will be in the future, such as “Late for a meeting.” By predicating future situations, the system is able to alert the user or act otherwise upon the predicted situation. For instance, the system is able to alert the user that the user should leave for a meeting by a certain time to avoid being late. In another example application, the System predicates the future location of the user and alerts the user of traffic delays, provides directions, etc. One of the sources used for prediction is stored and/or analyzed information relating to the user's past context, referred to in embodiments of the present invention as the “Context History,” as discussed further with regard to Past, Present and Future Context Information below.

The following discussion provides examples of how embodiments of the present invention address use of Past, Present and Future Context Information. One interesting way to look at Context-Information is to divide it into these three context-information types (Past, Present and Future Context Information), as follows:

Present Context Information—Information that describes the User's (or other Entity's) Present Context State.

Past Context Information (also referred to herein as “Context History”) Information that describes the Entity's Past Context State. To obtain more accurate results, the Interpreters of the present invention use ‘Past-Context-Information’ (History). For example, upon receiving conflicting information from two location sensors having the same accuracy, if the User is usually at a certain location at that time and day, the Interpreters determine that there is a better probability that the usual location is the right location. In addition, Past Context Information is substantially usable in the predictive use of the Context Engine.

Future Context Information—Information that describes what the system predicts will be the User's (or Entity's) Future State.

These features of the present invention are also usable with another aspect of the present invention, referred to in one embodiment as the user's “Privacy Policy” (Control). With this feature, users may elect to determine the type of Context Information the System is allowed to collect about them using the Past, Present, and Future definitions. For example, Users may set the Privacy Policy such that only Present Information may be collected by the System (and after 5 minutes this information is erased from the system, if not updated); or the system may be allowed to predict the user's future State (which typically is much more invasive). Similarly, for Past Context-Information, users are able to select an option to ‘turn-off’ collection of context history information.

An embodiment of the present invention includes the paradigm of separation of Data Acquisition, Business Logic, and Presentation from the world of enterprise applications, and inclusion of these features in a Context Aware Application, as follows: 1) Data Acquisition is analogous to the Collection tier; 2) Business Logic corresponds to the Analysis Tier and the interpreters that derive Context States; and 3) Presentation is on par with Context Action/Effect. In an embodiment of the present invention, the development paradigm and architecture is the recommended approach for logically partitioning and constructing scalable applications required of business-critical deployments. One application model includes a clear separation of Context Driven Actions/Effects, Context Analysis, and Context Information Collection, which, among other advantages, promotes code reusability and provides significant cost savings and faster deployment over more traditional approaches.

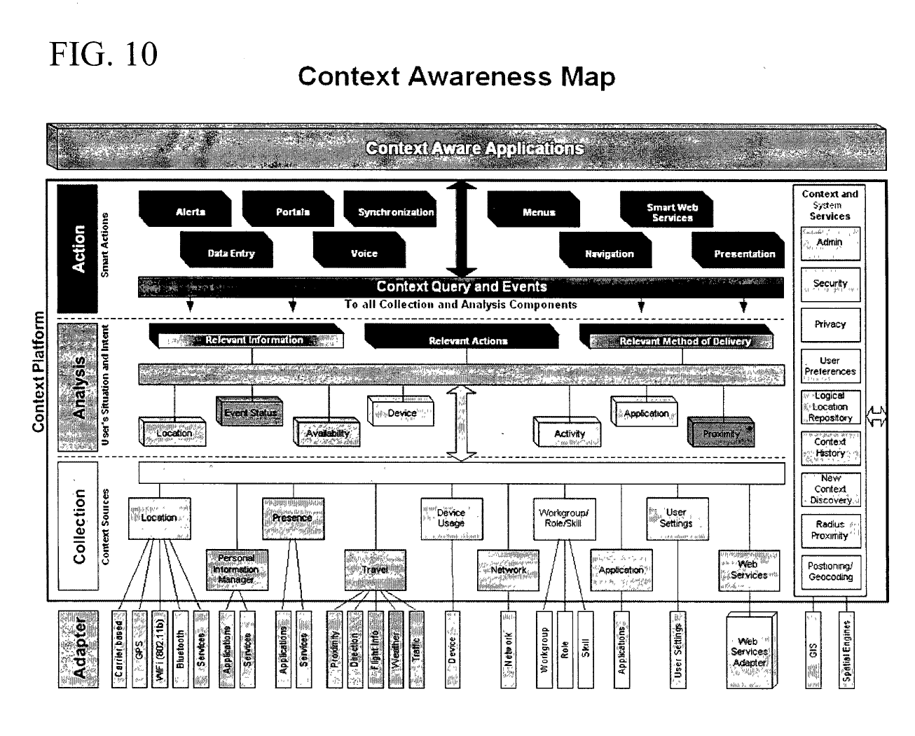

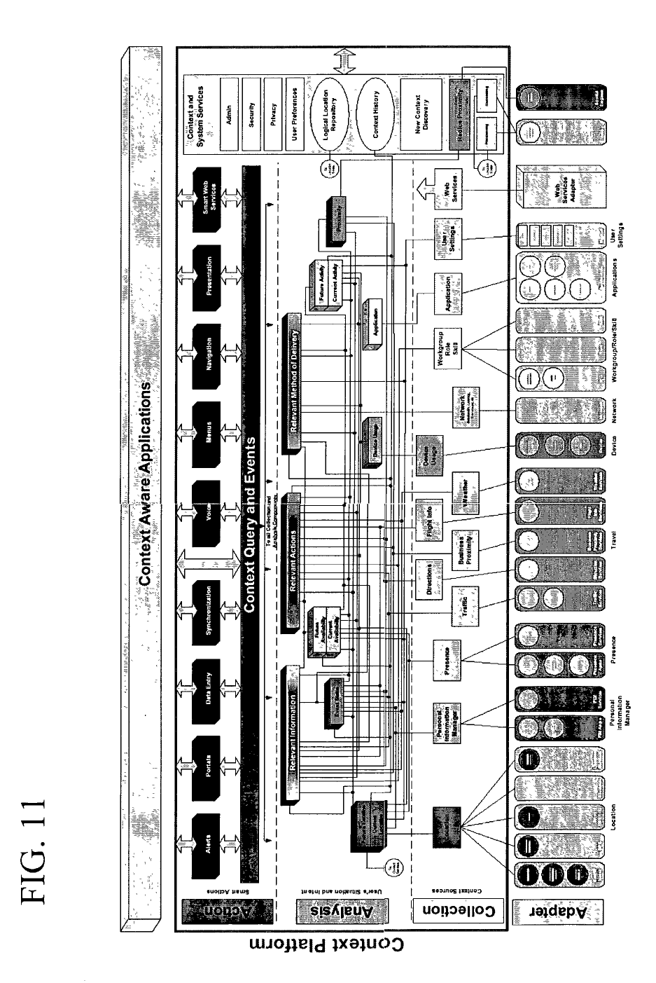

FIGS. 10 and 11 present variations of context awareness maps for determining context aware information and producing context aware applications, in accordance with embodiments of the present invention. Various features of the present invention, as shown in FIGS. 10 and 11, include the following.

Context Actions/Effects—Context Actions/Effects, in an embodiment of the present invention, are the manifestation of the user environment and activity adaptation in the application. These Context Actions/Effects are executable at the presentation, logic, or navigation level.

As aforementioned, the usage of context varies in accordance with various features of the present invention. Following are several examples for how Context can be used in various paradigms, in accordance with embodiments of the present invention.

Context Aware Map Component. In this case the well-known map presentation includes more than one option for delivery of information to the user, and these features may be considered to provide additional dimensions for presentation made possible by the architecture of the present invention. The map is representable, for example, as a graphical image, a set of directions to the next destination, or as a set of directions that are being read aloud. The following scenario illustrates how this map component functions, in accordance with embodiments of the present invention.

When the user is viewing, the next destination on the map is represented in the most intuitive way—graphical representation. When, for example, the user enters a vehicle and motion is detected, the graphical representation is replaced with directions with a large font size. As velocity increases, the map is represented as a set of the directions, but those are read aloud before any turn is needed.

Context Aware Navigation. Another manifestation of Context Awareness, in embodiments of the present invention, is the continual modification of the Navigational Model of the application. For example, an employee may be using a workflow engine with an approval cycle. As the employee is in the car with the boss, for example, the application does not require the employee to contact the boss for approval, as the boss's presence is sensed to be in the same car with the employee.

Yet another manifestation of context awareness includes modification of the application navigation. For example, if the user is presented with an option list that is part of the application, each option leads the user to a specific part of the application. Those options may be made irrelevant by the context state of the user (e.g., when the user is off work); some of the options may not be needed, as other options may be made possible instead.

Using Context to Determine Relevancy. Context Information can be very beneficial in systems that aim to provide users with Relevant Information, Relevant Actions, or Services and Relevant Method of Delivery. By applying the User's situation and Intent, the system of the present invention is able to infer what the user is interested in, or in some cases what the user is predicted to be interested in, and provide the user with relevant information. FIG. 12 illustrates how, by applying the various context states, the available information can be filtered into relevant information.

Context and Portals. Another factor involved in application of the present invention is the concept of enterprise portals. Portals are an example of a domain in which Context is usable to provide the User with Relevant Information and Services, in accordance with an embodiment of the present invention. Context can be highly used in Portals. For example, in existing applications, Portals can provide Relevant Information and Services based on static information, such as Identity or Role, or based on personalization. Portals facilitate people to process integration by exposing only those parts of multiple applications that users need in a consolidated interface. Among other advantages, portals make business applications more accessible to a wider audience of users by simplifying the number and type of application interfaces and the amount of training and maintenance needed to use them. Factors such as personalization, aggregation, and integration are important to portal concepts, and use of portals is generally appropriate when the capability to individually customize or personalize the user interface is important.

Additional advantages that result from use of portals include the following: 1) increased employee efficiency and productivity, since information is personalized and easier to find; employees can use fewer applications or sources to find information and complete tasks; 2) improved decision-making due to better access to more relevant information; 3) improved relationships with employees, partners, and customers via personalization and aggregation of information and services; 4) improved corporate communications to employees and among employees; and 5) increased revenue due to partners having better access to up-to-date product information and services.

In accordance with embodiments of the present invention, Context can be highly used in Portals. In existing applications, Portals can provide Relevant Information and Services based on static information, such as Identity or Role, or based on personalization. By applying the User's context, in accordance with embodiments of the present invention, Portals are able to provide the user with even more relevant information and services. In particular, in an embodiment of the present invention, Portals used with Context provide the User with information and services that are relevant to the current situation of the user. Also note that such usage of context with portals represents situation context influencing another software application (e.g., the portal software) to affect the user experience in any environment in which the portal is accessed (e.g., mobile, desktop, or otherwise).

Context and Alert Engines. Another domain Context is usable with embodiments of the present invention is with a feature referred to as Alert Engines. Context can be applied to provide the user with relevant alerts, according to context states, or in other words, according to the situation and intent of the user, including, for example, information obtained regarding relevant method of Delivery, such as send Alert to the desktop PC if the user is currently active at the desktop, or send Alert to PDA or Telephone if the user is currently remote and available (e.g., based on the User situation and intent).

Context and Voice Engines. Another domain in which Context Information is usable with embodiments of the present invention is with a feature referred to as Voice Engines. Applying Context can improve the User Interaction with voice systems, for example, by reducing the amount of explicit information required from the user. For example, instead of using specific commands, such as “Show Directions from 7010 Gentle Shade Rd., Columbia, Md. to 9101 Guilford Rd., Columbia, Md.,” where the likelihood for error is high, the user could reuse patterns, such as: “Show Directions to next Meeting,” in which the System interprets such information as the user's intention by applying the User's Context States, the user current location, or the user's next meeting details. By using these short patterns, the likelihood for errors is significantly reduced, and the user is able to use short sentences/commands.

Context and Data Entry. In embodiments of the present invention, Context can be used to mask the complexity of entering data into devices, such as PDAs, telephones, and PCs. The System is able to pre-populate input fields or prompt the user for input based on such information-as the User's Context (e.g., the user's situation and intent). For example, consider a service portion of the present invention that provides directions, and that prompts for the origin address and the destination address. To provide such information using a cellular telephone is almost an impossible task. By using the User's context states, the System can pre-populate the screen with the origin information (e.g., the User's current location state), and what is likely to be the destination (e.g., the user's next event), and simply prompt the user to confirm this information. By applying the User's context states, the system is able to reduce significantly the interaction between the system and the user, while providing the user with the same results.

Context and Synchronization. Current mobile devices are low in memory, and furthermore, syncing over a wireless network can be almost an impossible mission, due, for example, to latency issues. To address this problem, embodiments of the present invention can be used by sync platforms to reduce the amount of information to be synced, thus reducing the sync time and volume. Using the context information sync platform can reduce the amount of information, enhance deduction of what is the relevant information, and increase the likelihood of determining of what is of interest to the user. To be able to determine what is relevant, or what is the user is interested in, the system applies the User's Context, including static and dynamic context, as well as Preferences—the user's predefined preferences; the user's preferences can, in addition, define how to apply the Static and Dynamic Context.

Context and Menus. Menus are included in common user interfaces used with almost any computer based device. A typical Menu includes a list of actions that a user can perform. Most of the Menus today are static (e.g., static list of actions), or based on the application state. In an embodiment of the present invention, Context can be used to provide users with more relevant actions in Menus. In this embodiment, actions are associated with the User's situation and intent (e.g., the User's context). For example, a user can be provided with different actions for the same menu based on current location.

Context and Machine-to-Machine. While many of the examples discussed above involve influencing the interaction of a system with a user, in accordance with embodiments of the present invention, context is also usable to influence the interaction among devices (e.g., machine to machine interaction or between applications and machines). For example, knowing the situation that an office building is empty of people after a certain time can trigger the light system to shut down and the security system to be activated. Knowing that the number of people in a particular room of specified capacity can trigger a thermostat to adjust the temperature downward or trigger a capacity warning event if the room capacity is exceeded. Thus, context is usable to improve the effectiveness of devices in a similar fashion to improving the effectiveness of an actual user.

In an embodiment of the present invention, the Context Framework provides a flexible architecture, allowing for various implementations for use in building context aware applications. This framework supports the collection, analysis, and action tiers.

The Architecture and development paradigm discussed above may be implemented in many ways with many technologies, in accordance with the present invention. Regardless of the specific technologies selected, some assumption can be made with regard the characteristics of the implementation, such as the following: 1) Distributed Computing Environment (e.g., J2EE, Jini, NET—the use of industry standard XML interfaces for communication with third party application and context sources); 2) a flexible Query language to satisfy context awareness logic; and 3) a synchronous and asynchronous operation.

Building Framework Context-Components and employing the framework services, in accordance with embodiments of the present invention, will now be described in greater detail. The tier for these framework related features facilitates the collection of Context Parameters. Collection of Context Parameters may be a very complex task: the information is gathered from distributed machines, and, among other things, Context Parameters are diverse and the availability of these parameters is volatile. This tier masks the complexity of Context Parameters, their availability, and how they are being accessed. For example, in embodiments of the present invention, the developer is able to create new Context Sensors and re-use existing ones, as long as they conform to the framework-defined interface. The Analysis Tier provides an abstraction layer to the Developer by analyzing Context Parameters and presenting the result in a uniform way.

Low-level Context sensory information is difficult to address. To mask the complexity of low-level Context Parameters from the application developer, in an embodiment of the present invention, the Context Framework provides the Analysis tier, which enables the Developer to define multiple layers of abstractions above low-level Context Parameters. A Context State represents the result of the analysis on various Context Parameters and/or Context States. For example, the application developer is not likely to find the user's longitude/latitude useful; however, the fact that the user is at a customer site is very useful. Furthermore, the application may need to know if the user is driving, is late, etc.

The Analysis Tier of an embodiment of the present invention also enables the developer to re-use scenarios for various applications. When creating a new Context State, the developer may use Context Parameters, as well as other Context States.

In embodiments of the present invention, Context States provide various levels of abstraction. Some Context States provide higher abstraction than other Context States. For example, the location context state may be defined as follows: Location in the form of longitude/latitude and “at office”/“at home”/“at customer.” Longitude/Latitude may be regarded as a lower abstraction than “at office”/“at home”/“at customer.” In an embodiment of the present invention, the Developer indicates the level of abstraction of each Context State.

In an embodiment of the present invention, the Action Tier combines context states to derive the objective of the user, resulting in actions that modify the application. Actions are applied to the presentation, navigation, or the application logic of an existing application, or even to launch another application.

The Context Framework collects the Context information (e.g., Context States and Context Parameters) relative to an Entity. An Entity is a person, place, or any other object considered relevant to the interaction between a user and an application. In an embodiment of the present invention, the developer is able to obtain a list of existing Entities in the Context Framework.

In an embodiment of the present invention, the Developer is able to obtain a list of all available Context States in the Framework.

In an embodiment of the present invention, the Developer is able to obtain a list of all available Context States of a certain Entity, such as, for example, all Context States collected on the entity ‘Sharon Agam.’ In an embodiment of the present invention, the Developer is able to explicitly obtain the Context State of an Entity.

In an embodiment of the present invention, the Subscribe feature enables the application to be notified when change occurs; this may be used in lieu of the feature of embodiments of the present invention referred to as “Get Context State.” In an embodiment of the present invention, this feature further masks the complexity of dealing with the often occurring changes of Context States. An embodiment of the present invention includes a feature referred to as “Get the Attributes,” which obtains the attributes of an Entity's Context State, enabling the developer to obtain the attributes of a context state of an Entity.

In an embodiment of the present invention, the Developer is able to access Context Parameters; usually this is used to create new Context States.

Description of Context Engine Architecture

The Context Engine Architecture, in accordance with embodiments of the present invention, will now be discussed in greater detail.

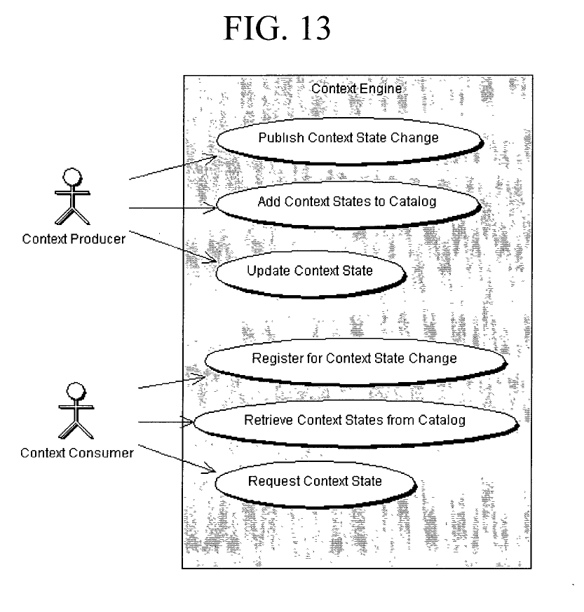

FIG. 13 presents an example UseCase Diagram of architecturally significant use cases, in accordance with an embodiment of the present invention, which includes the following features, referred to herein as “actors” and “usecases.”

Actor Context Consumer. This actor includes any component that requires either asynchronous notification of Context State change events or synchronous access to Context State Producers. In an embodiment of the present invention, the components of this actor are located either inside or outside of the system boundaries of the Mobile Context Engine (e.g., at a Wireless Application Client or an Interpreter, respectively).

Actor Context Producer. This actor is any component that generates or modifies a Context State. Typically, in embodiments of the present invention, this actor asynchronously generates Context State change events due to changes to the application's environment, although this actor can also have synchronous request operations to enable point in time access to the Context States produced. In embodiments of the present invention, some of these producers interface with external services, which asynchronously or synchronously provide the raw data, or parameters, that are transformed into a Context State.

UseCase Add Context States to Catalog. In embodiments of the present invention, the Context Framework provides a catalog service that contains a list of all Context States (e.g., schedule, location, and motion). Upon initialization of the system of the present invention, Context Producers registers the Context States that they can generate with the catalog service. The service ensures that the list of states is unique.

UseCase Publish Context State Change. In embodiments of the present invention, upon generation of or update to a Context State, Context Producers deposits Context State into a repository for persistence. A notification service is informed of the change event and is passed the associated Context State, resulting in the broadcast of the change event to all requesting Consumers.

UseCase Register for Context State Change. In embodiments of the present invention, the Context Framework enables Context Consumers to request and receive notification upon the creation/update of specific Context States. The Consumers are able to access well-known services that provide the notification service. The Context Framework provides standard interfaces to register for and to process such Context related events.

UseCase Request Context State. In embodiments of the present invention, Context Consumers are able to synchronously request an update to a specific Context State from a Context Producer.

UseCase Retrieve Context States from Catalog. In embodiments of the present invention, Context Consumers are able to retrieve a list of valid states within the Context Engine. The states have an abstraction level associated with them, and the Consumer can request the states of a specific abstraction level, range of abstraction levels, or set of abstraction levels.

UseCase Update Context State. In embodiments of the present invention, the interface of Context Producers enables Consumers to request the update of a specific Context State.

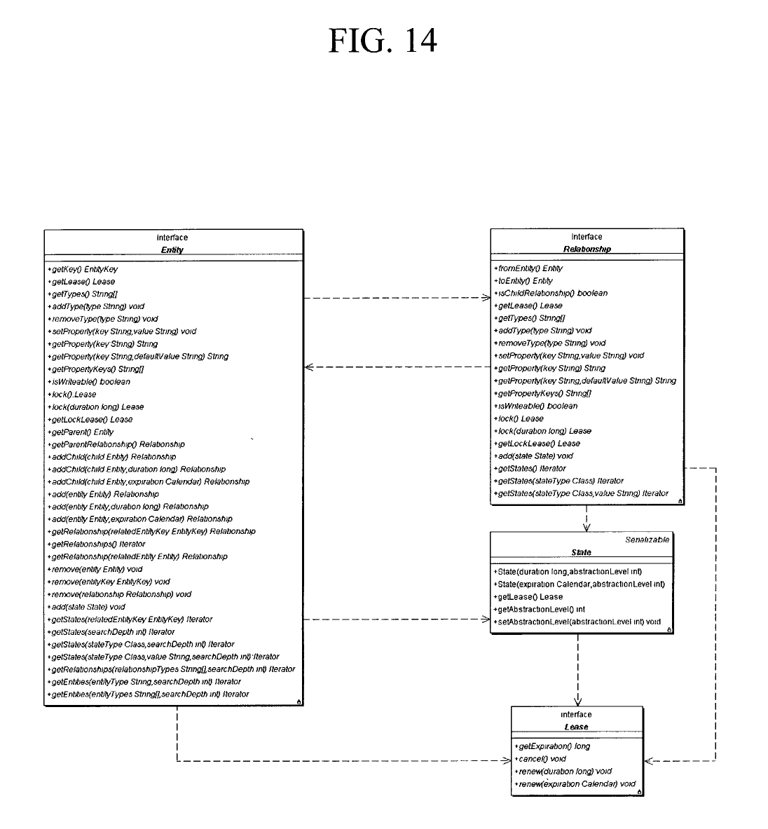

FIGS. 14-24 contain logical block diagrams of various components of the present invention, reflecting, for example, software, such as Java programming, used to perform functions for these components.

FIG. 14 shows as Class diagram of a domain model, in accordance with an embodiment of the present invention. As shown in FIG. 14, the context domain model includes three main classes: Entity, State, and Relationship. This structure provides the flexibility necessary to represent a complex environment and its state, which is collectively referred to as ‘Context State.’

FIG. 15 is a Collaboration diagram of an example context state domain model, in accordance with an embodiment of the present invention. As shown in FIG. 15, when modeling a context state, in accordance with an embodiment of the present invention, three types of relationships are represented to accurately depict a context state, as follows: 1) Entity has a state (e.g., Tim is Busy); 2) the relationship between two entities has a state (e.g., Tim is late for Flight 1043); and 3) an entity's state effects another entity that has a relationship to that entity (e.g., Tim's mobile telephone is at home). These three types of relationships can be combined in infinite ways to accurately represent the context state of an environment.

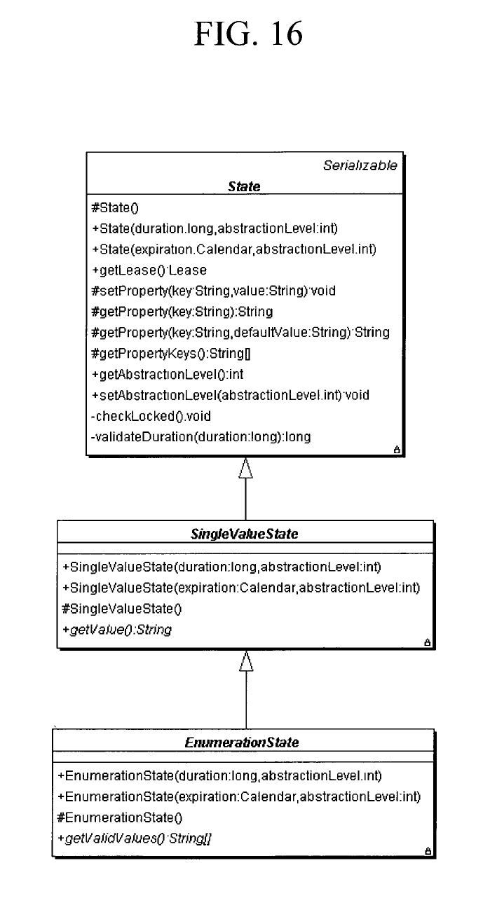

FIG. 16 contains a Class diagram of state hierarchy, in accordance with an embodiment of the present invention.

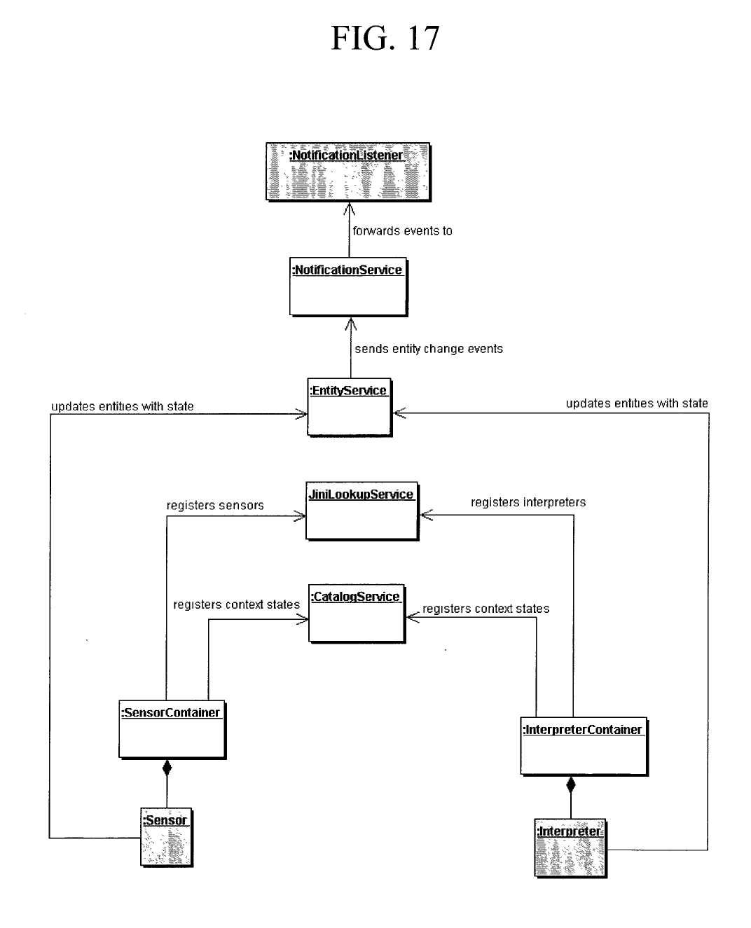

FIG. 17 is a Collaboration diagram of relationships of services functions, in accordance with an embodiment of the present invention. As shown in FIG. 17, the relationships between the components of the Context Engine at runtime are presented. Objects in shaded boxes represent components that are outside the scope of the Context Engine framework. The framework provides the specifications to allow plugin of these components into the engine.

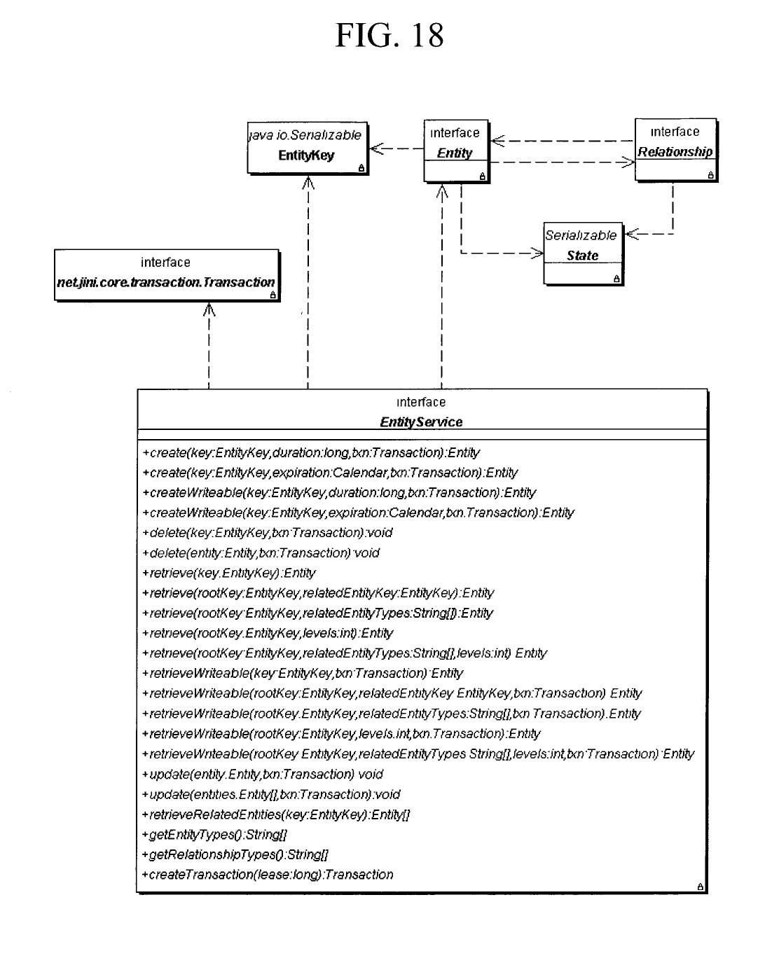

FIG. 18 presents a Class diagram of entity service functions, in accordance with an embodiment of the present invention.

FIG. 19 contains a Class diagram of notification service functions, in accordance with an embodiment of the present invention.

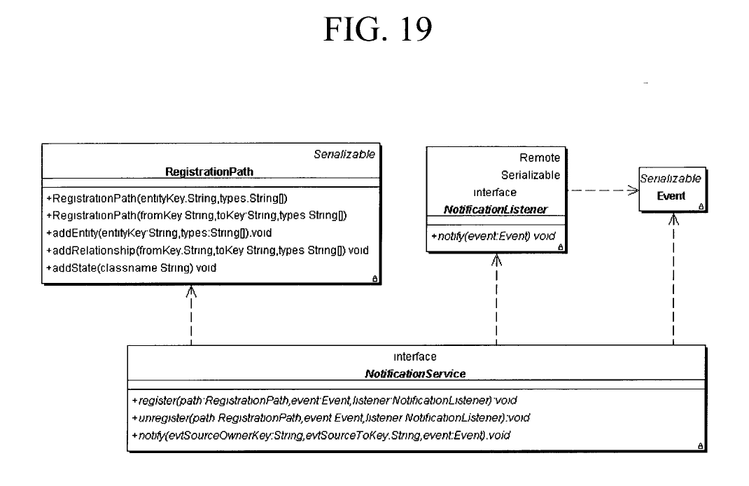

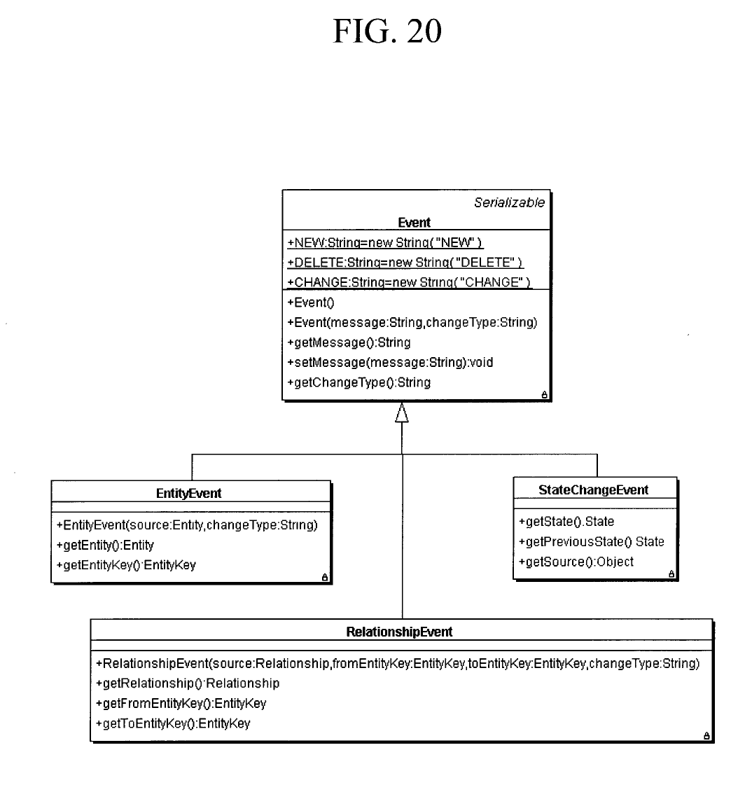

FIG. 20 is a Class diagram of event hierarchy structure, in accordance with an embodiment of the present invention.

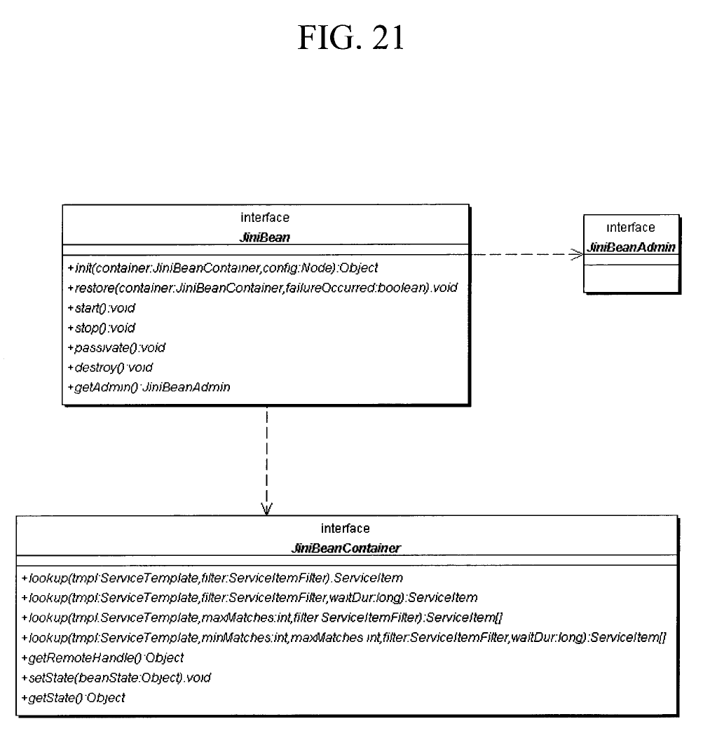

FIG. 21 presents a Class diagram of a JiniBean model for use in accordance with an embodiment of the present invention.

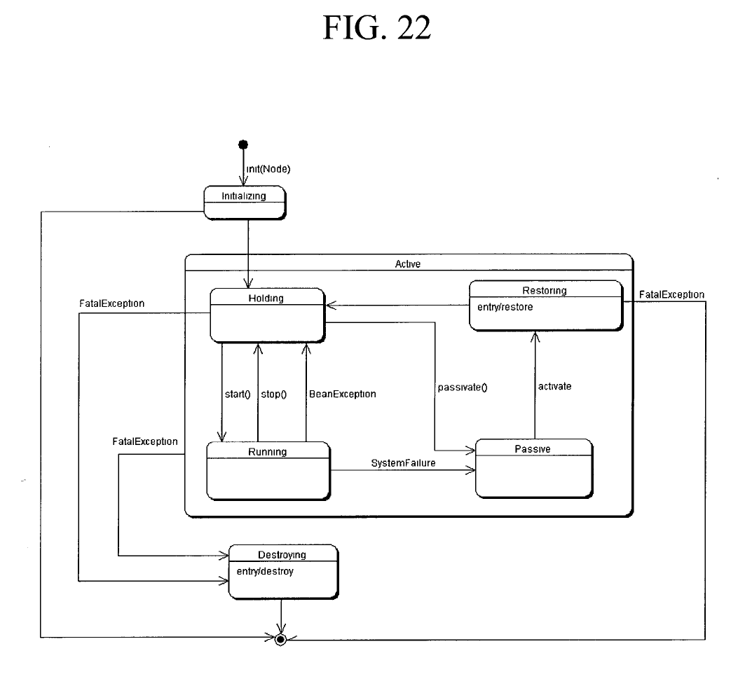

FIG. 22 contains a Statechart diagram of a JiniBean state model for use in accordance with an embodiment of the present invention.

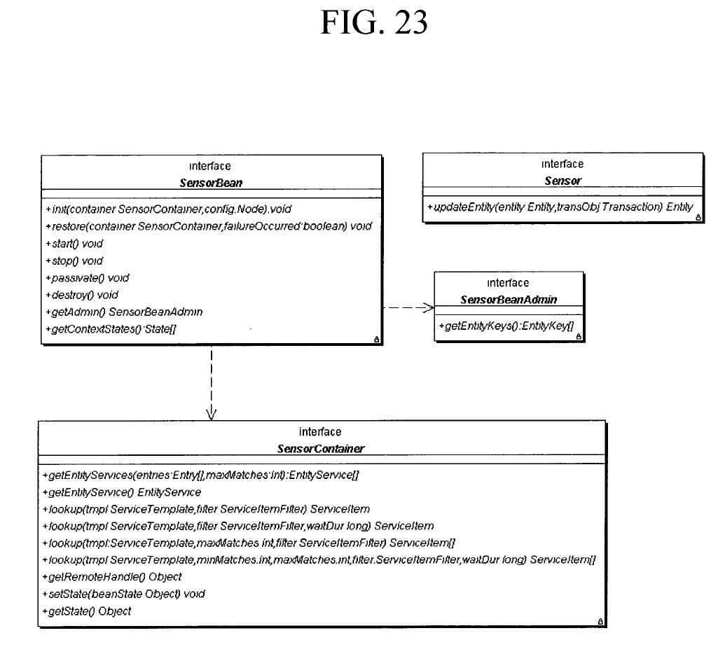

FIG. 23 is a Class diagram of a SensorBean model for use in accordance with an embodiment of the present invention.

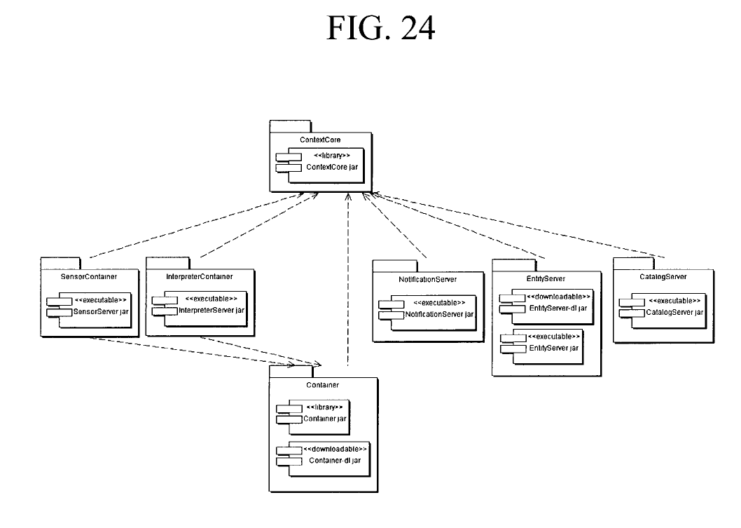

FIG. 24 provides a components diagram of context engine components, in accordance with an embodiment of the present invention.

Appendix B contains additional details of various program functions, in accordance with embodiments of the present invention.

Description of Example Context Pack Architecture

A more detailed description of an example Context Pack Architecture (also referred to herein as “Context Pack”) will now be provided, in accordance with an embodiment of the present invention.

The Context Pack provides a framework to develop a context-aware application. In an embodiment of the present invention, the Context Pack provides access to a user's context that is affected by location, schedule, and state, and also allows management of the effect of the context of other users on the user's context. In an embodiment of the present invention, the Context Server provides the underlying Context framework, and the user's context is accessed through queries and events. The data needed to determine context is provided by external data sources through sensors. The Context Pack provides a framework to plug in various data sources into the sensors. The interpreters interpret the data and changes to a context are reported through subscribed events.

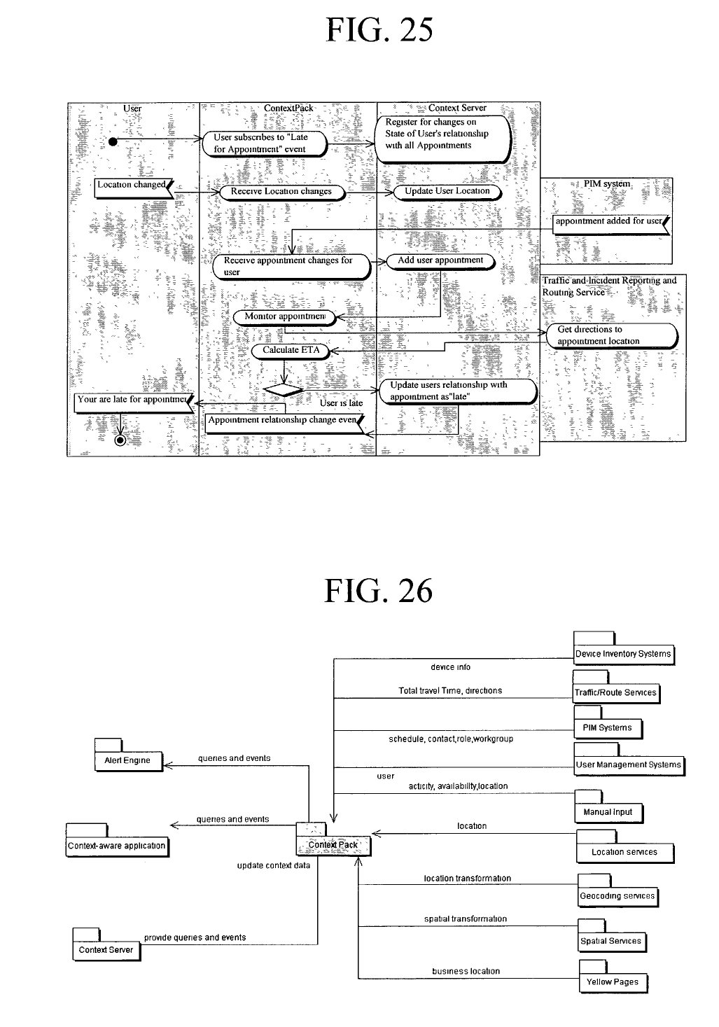

In an example application of the Context Pack, a user is subscribed to a late for appointment event. FIG. 25 provides an Activity diagram for generating an example event for the user being late for an appointment, in accordance with an embodiment of the present invention. In FIG. 25, the following activities occur: 1) the user subscribes to the Late for Appointment event with the Context Pack; 2) the Context Pack registers with the Context Server to be notified of changes to the state of the relationship between the user and all appointments; 3) whenever the user location changes, Context Pack is notified, and the system updates the user location on the Context Server; 4) when an appointment is added, the Context Pack updates the information with the Context Server; 5) the Context Pack starts monitoring the appointment by obtaining the estimated time of arrival (ETA) and comparing the ETA with the appointment start time; 6) if the ETA is after appointment start time, Context Pack updates the state of the relationship between the user and that appointment to “Late”; and 7) the Context Server sends a notification to the Context Pack, which then forwards it to the user.

The example shown in FIG. 25 describes an example of how Context Pack uses external data sources and the Context server to determine the user's context and notify the user of any changes. The example is very simplistic in nature. In actual implementation, in accordance with an embodiment of the present invention, many more rules are applied before monitoring of appointments starts.

The example shown in FIG. 25 assumes that the user and an appointment entity are created in the Context Server. The Context Server provides a very basic framework to manage a context. The Context Pack isolates the complexities of the Context Server and provides a framework to build context-aware applications, based on users, location, schedule, traffic, and proximity, and the Context Pack determines availability and activity based the context.

In an embodiment of the present invention, the developer does not need to know the complicated graph representation of various entities, relationships, and states. Information is presented to the user in a very simplified manner. The Context Pack defines a Context Model that allows representation of a User's context related to location, schedule, traffic, and proximity.

In an embodiment of the present invention, one system purpose of the Context Pack is to sense change in user related data, interpret the data using user's context, and present the data to the user on demand or by notification. FIG. 26 is a flow diagram of the flow of information to and from the Context Pack, in accordance with an embodiment of the present invention.

As shown in FIG. 26, data from various sources enters the Context Server through the Context Pack. The Client Applications then use the Context Pack to query data or receive notification of the data changes. The User Management Systems provide information about the users whose context is being managed and determined. The Device Inventory Systems provide information about the devices that the user owns (e.g., PDA, GPS, Cellular Telephone). The PIM Systems provide information about a user's schedule and optionally also provide additional information about the user. The PIM systems optionally also provide information about the Workgroups to which the user belongs.

In an embodiment of the present invention, Location Services provide a user's location information. The location information is generally tied to the location of the device that the user owns. Traffic and Route services provide directions and traffic information. These services provide the best possible route to a given destination and also estimate the travel time for the route. The service may also provide reports of incidents on the route. Geocoding services provide conversion between latitude/longitude location values to addresses or zip code. These services also provide reverse geocoding conversions.

In an embodiment of the present invention, Spatial Services provide functions for calculating proximity between two locations. Yellow Pages provide business locations (e.g., Restaurants, Shops). In an embodiment of the present invention, users are also able to provide information manually about their activity, availability, and location. The Client Applications, including the Alert Engine, query or subscribe for contextual data using the Context Pack. The Context Pack uses the Context Server services to obtain the required information and passes that instruction on to the client applications.

Overview of Context Pack

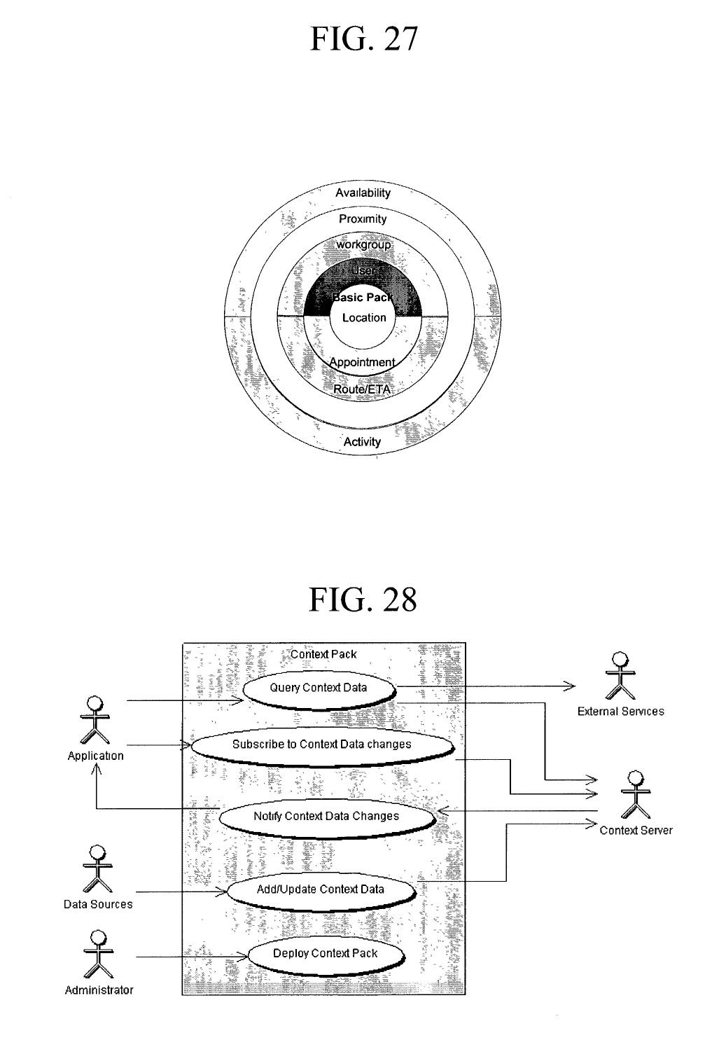

In an embodiment of the present invention, a Context Pack includes a set of subsystems that integrate with the Context Server to provide contextual information about particular data associated with the user. The basic data needed for determining a user's context includes the user's location and schedule. The location and schedule sensors provide data to the Context Server. The Interpreters interpret that data to determine the user's context. The Query and Event service provide access to the interpreter context. A different set of sensors, interpreters, model, query, and event services are provided for each set of functionality, be it, for example, location, schedule, ETA, workgroup, or availability. Each set of sensors, interpreters, query and event services forms a context pack. FIG. 27 shows a representative diagram of the Context Pack Layout, in accordance with an embodiment of the present invention.

As shown in FIG. 27, in an embodiment of the present invention, the Basic Pack handles the information about the user, the user's appointments, the user's location, and the appointments location. The Workgroup Pack handles information about users in a workgroup. Route (ETA) Pack handles route and direction information related to user traveling to an appointment or any other location. Proximity deals with information about the distance between users and location. Proximity also uses the Route (ETA) pack to determine time proximity. Activity Pack determines the user's and workgroup's activity. Availability pack determines user's and workgroup's availability.

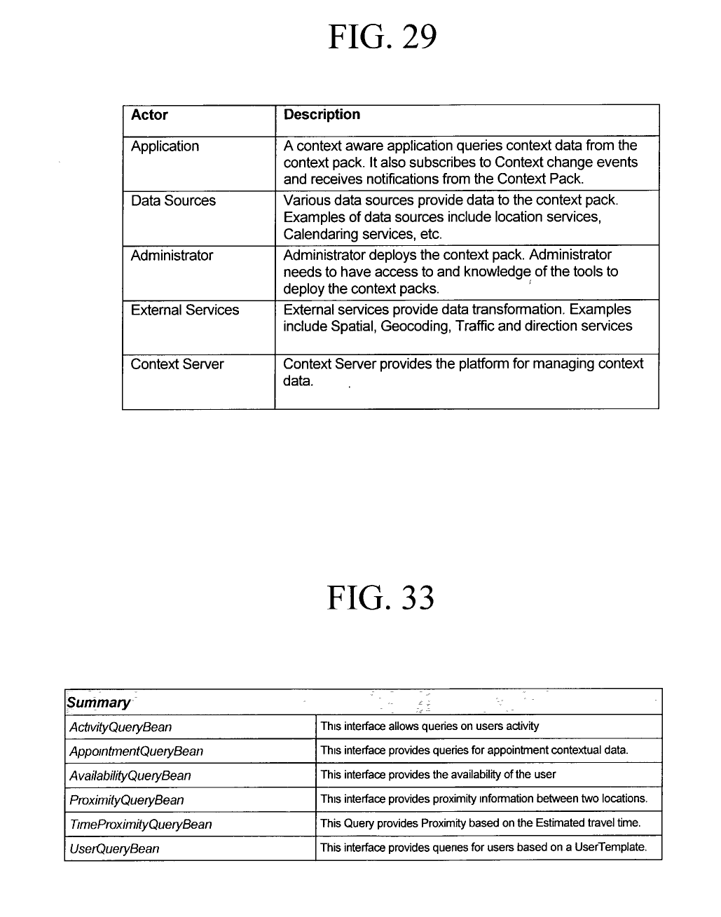

FIG. 28 is a representative diagram of the high level external interfaces to the Context Pack system. The actors involved in the process for the diagram of FIG. 28 are provided in the table shown in FIG. 29.

The logical view of the static structure of the architecture in terms of its components, their interconnections, and the interfaces and operations offered by the components, in accordance with an embodiment of the present invention, will now be presented.

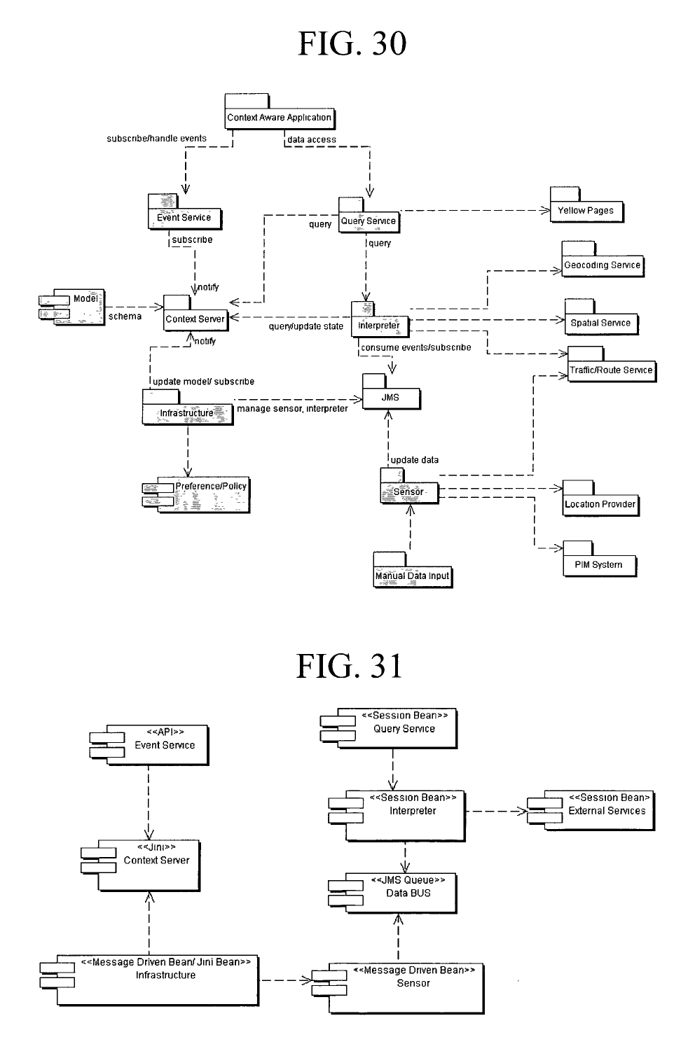

FIG. 30 presents a representative diagram of the overall architectural structure of an embodiment of the present invention. FIG. 30 shows a high level view of the Context Pack and its dependency to other systems and subsystems. Each of the subsystems is explained in detail further below. Some important features of the architecture of an embodiment of the present invention include the following. In an embodiment of the present invention, the architecture is J2EE based. This architecture provides scalability and other advantages, as well as allowing portability across various J2EE application servers In an embodiment of the present invention, JMS is used for communication among the sensors, infrastructure, and interpreters. Users are completely isolated from the Context Engine and model. The client application uses the query and the event service to access Context Information. Sensors use standard data format and JMS to update data into the context model.

FIG. 31 shows a representative diagram of the technology for each component in the Context Pack for an embodiment of the present invention.

In an embodiment of the present invention, the Client Application queries Context Pack data using the Query Service. The Query Services components are divided by the data that each query supports, as follows: 1) CoreQueryBean supports queries on the User, the user's location and appointment schedule (e.g., obtain a user's current location, obtain a user's current appointment, obtain a user's today's schedule); 2) ActivtyQueryBean supports queries on user's activity (e.g., is a user in a meeting?); 3) WorkgroupQueryBean supports queries on a workgroup (e.g., find all user's in Sales who are attending a meeting at a particular location); 4) ProximityQueryBean supports queries on a user's proximity to other users in the system or to a location (e.g., the location could be a location of an appointment or a business); and 5) AvailabilityQueryBean supports queries on user's availability; availability optionally is manually set by the user or is determined by the user's current activity (e.g., do not notify the user via telephone if the user is unavailable or in a meeting).

In an embodiment of the present invention, the QueryService depends on the Interpreters to interpret user's context (e.g., user's location could be provided by various devices). The Interpreter decides which location is the most accurate, or, if, for example, location is not available, uses the user's schedule for determining the user's most accurate location. This location is then used by the Query Service to return a user's information. The QueryService also obtains proximity, activity, and availability information from the interpreter. For simple information, such as current appointment, the QueryService directly uses the Context Server to retrieve the information. The QueryService also uses external services, such as Geocoding Services, to convert location data (e.g., position is converted to an address).

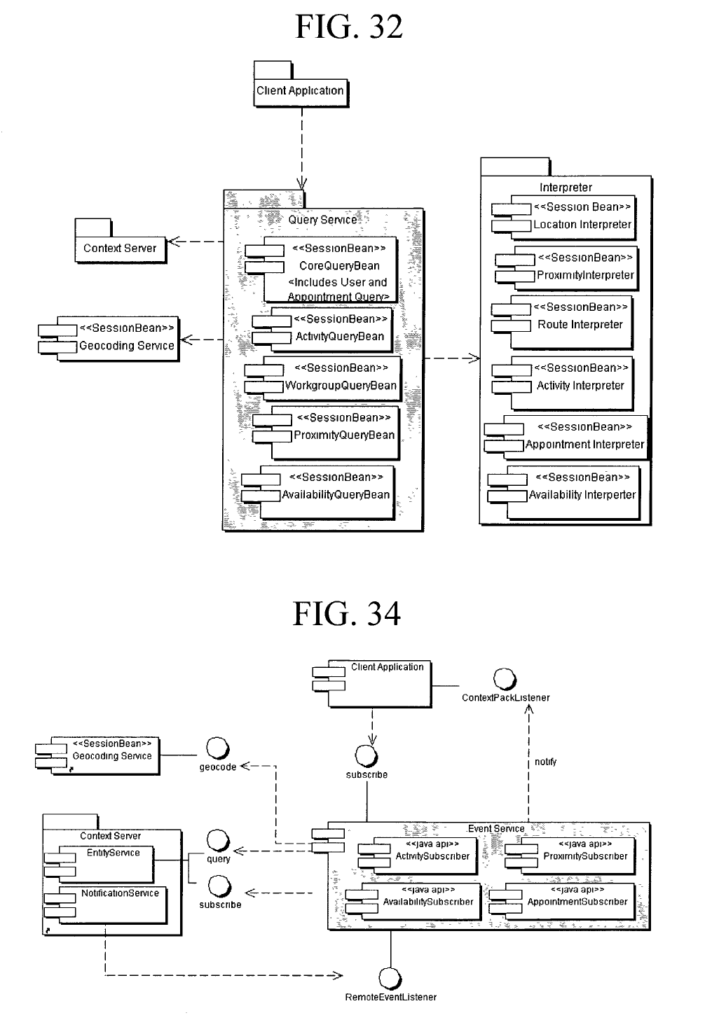

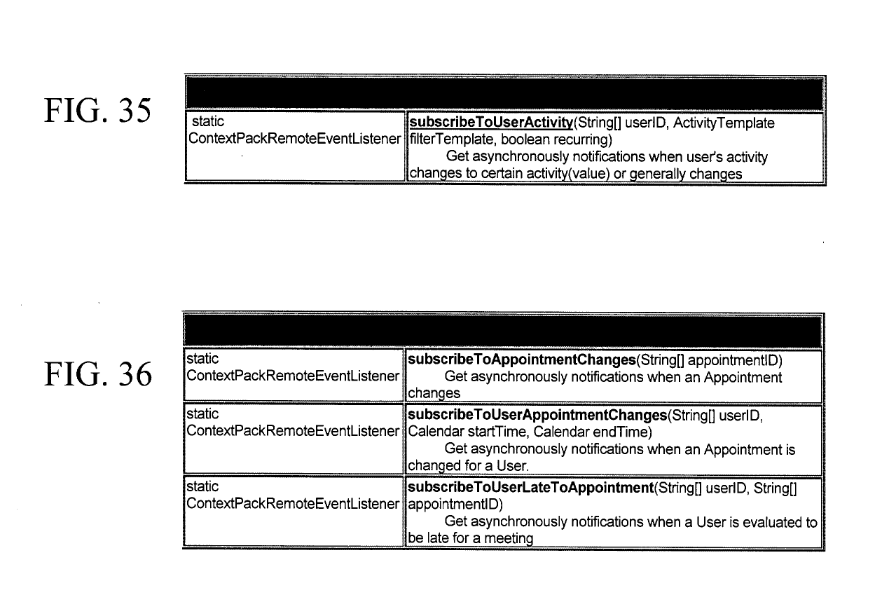

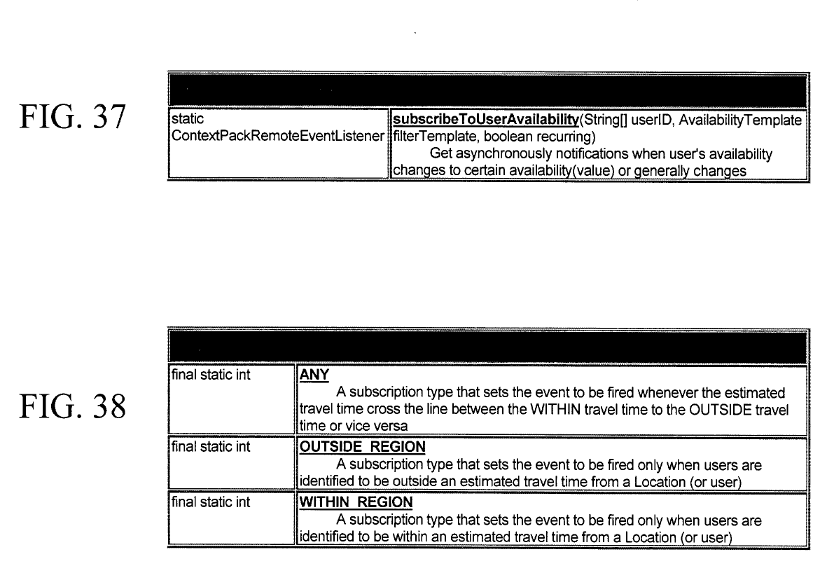

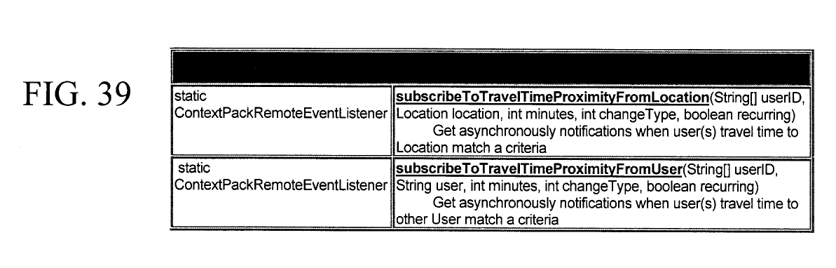

FIG. 32 is a representative block diagram of an example query service subsystem and its dependencies, in accordance with an embodiment of the present invention. FIG. 33 provides a table of summary information relating to the query service subsystem, in accordance with an embodiment of the present invention. More detailed description of various components of the interface is provided in Appendix C. In an embodiment of the present invention, the interface is used by Client Applications to Query Context data.

In an embodiment of the present invention, client applications subscribe to receive Context Pack events using an event service. The Client application implements a ContextPackListener for each type of event and registers the Listener with the Event Service. The Event Service invokes a callback method on the Listener when an event occurs, thus notifying the client of the event. The Event Service components, in accordance with an embodiment of the present invention, include the following: 1) AppointmentSubscriber—allows Client Applications to subscribe to Appointment changes (e.g., subscribe to a Late for Appointment event for a user); the application is notified when the user is late for any appointment; 2) ProximitySubscriber—allows Client Applications to subscribe to proximity events; applications can subscribe to be notified when a user is located within or outside an area of a specified radius; 3) AvailabilitySubscriber—allows Client Applications to subscribe to changes to User's availability (e.g., notify the application when a user is available for a meeting); 4) ActivitySubscriber—allows Client Applications to subscribe to changes to User's activity (e.g., notify the application when the user is in a meeting).

In an embodiment of the present invention, the EventService uses the Context Servers Notification service to register for Context Events and converts the events to appropriate notification callbacks to the Client Applications. A subscription by an application is converted to an equivalent registration on the Context Server Model (e.g., when an application subscribes to a Late for Appointment Event for a User, the Event Service registers changes to the state of relationship between a user and all appointments). In an embodiment of the present invention, the Event Service is notified when any change in the state occurs. The Event Service then gathers all the information related to the event (e.g., for appointment, it could be the appointment details, the traffic information for the route to the appointment.) The Event Service also depends on the Geocoding Service to convert position data.

FIG. 34 is a representative block diagram of the event service feature of the Context Pack, in accordance with an embodiment of the present invention. Detailed description of the Event Service interfaces is provided below.

Various aspects of several event service features of the present invention are also described in greater detail in Appendix C.

The Interpreter Subsystem of an embodiment of the present invention will now be described in greater detail. In general, the interpreter subsystem interprets data that is entered into the Context Pack system. The interpreter, in accordance with an embodiment of the present invention, performs the following functions: 1) interprets data on demand, when QueryService requests information or the interpreter registers for changes (e.g., QueryService requests user's location); and 2) registers for changes to context data and interprets and updates context data when the data changes (e.g., Interpreter registers for changes to a user's location); when the user's location changes, the interpreter calculates the user's proximity to a registered location and then updates the proximity state.

In an embodiment of the present invention, the interpreter subsystem supports the following interpreters (note: the architecture provides for extensibility and new interpreters can be easily added):

Location Interpreter interprets user location. A user's location can be provided by more than one device (e.g., a GPS receiver, cellular telephone). The location interpreter determines the most accurate location, based on location rules. If device location is unavailable, the interpreter uses the user's schedule to approximately determine user's location.

Appointment Interpreter interprets Late for Appointment state. The interpreter determines if the user is late for appointment by calculating the ETA at the appointment location, based on user's current location and the traffic conditions, and determines if the user can reach the appointment in time.

Route Interpreter interprets route information by monitoring route data and incident reports and applies them to appropriate entities.

Proximity Interpreter interprets proximity information. This interpreter registers to listen for user location changes and then recalculates the proximity state of a user with a specified location.

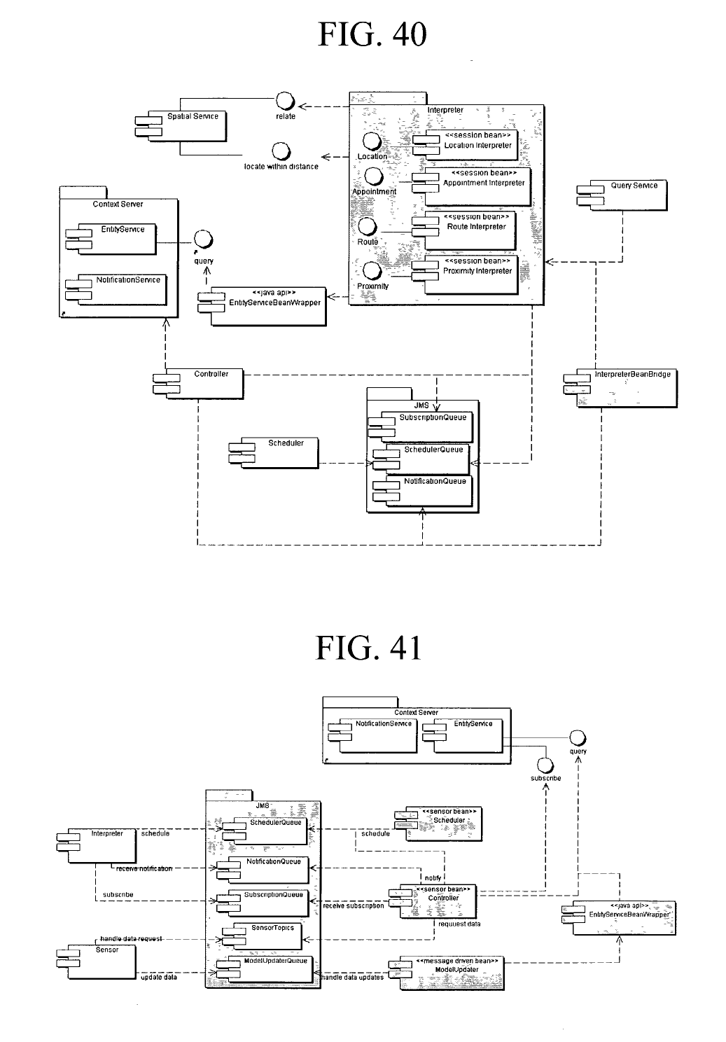

In an embodiment of the present invention, the interpreter subsystem uses the EntityBeanWrapper to communicate with the Context Server. Interpreter Bridge acts as a bridge between the interpreter and Notification service. FIG. 40 contains a representative block diagram of an interpreter subsystem, in accordance with an embodiment of the present invention.

In an embodiment of the present invention, the infrastructure subsystem provides the infrastructure for the following functions: 1) communicate with the Context Server; 2) schedule data requests; 3) receive and request data from the sensor; 4) register and receive events from the Context Server.

In an embodiment of the present invention, the infrastructure subsystem includes the following components.

Controller controls the data in the context pack. Controller manages the lifecycle of the data in the context subsystem (e.g., when a user is added into the system, the controller requests the sensors to provide appointment information for the user). The Interpreters register with the controller to receive notification on changes to context data.

Scheduler schedules jobs (e.g., the scheduler is used by the controller to schedule user location requests).

ModelUpdater receives data from the sensors, converts the data to Context Information, and updates the context server using the EntityServiceWrapper.

In an embodiment of the present invention, all the infrastructure components communicate with the sensors and interpreters through JMS Queues.

FIG. 41 is a representative block diagram of an infrastructure subsystem, in accordance with an embodiment of the present invention.

In an embodiment of the present invention, the sensor subsystem inputs data into the Context Pack. Sensors write data in specified format into the ModelUpdaterQueue. These sensors can include, for example, device data sources, such as cellular telephone locating devices or GPS devices, or other data sources, such as repositories of data (e.g., databases on PCs, minicomputers, microcomputers, or mainframe computers). The server, as well as other portions of the system, may include or be located on processors, such as PCs, minicomputers, microcomputers, or mainframe computers. The sensors and server and/or other components may be coupled, using, for example, wired, wireless, or fiber optic links, and may be coupled via networks, such as the Internet or telephone networks. In an embodiment of the present invention, Sensors are of three types: 1) synchronous sensors provide data when requested; 2) passive asynchronous sensors periodically push data into the Context Pack system; 3) active asynchronous sensors periodically push data into the Context Pack system. The Context Pack can also control the asynchronous data by subscribing and unsubscribing to the data.

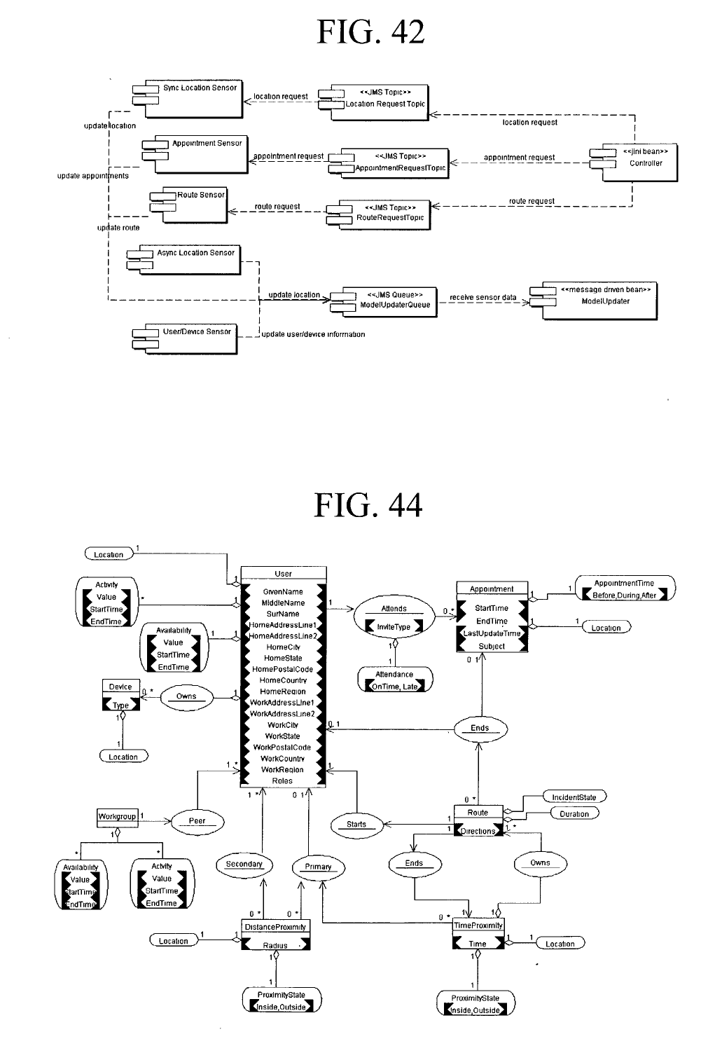

FIG. 42 provides a representative block diagram of a sensor subsystem, in accordance with an embodiment of the present invention. As shown in FIG. 42, synchronous sensors listen to their respective topics for data requests from the controller. To update data, the sensors convert the data to the defined Context Pack format and send the data to the Model Updater Queue.

In an embodiment of the present invention, the Sync Location Sensor provides location information on request. Appointment sensor provides appointment location on request. A Route Sensor provides route information on request. An Async Location sensor pushes location data into the context pack periodically or when the a user's location is updated. A User/Device sensor provides user and user device information on to the Context Pack.

In an embodiment of the present invention, sensors provide data in the form of XML. The Context Pack defines the XML DTD for location, appointment, route, and traffic information.

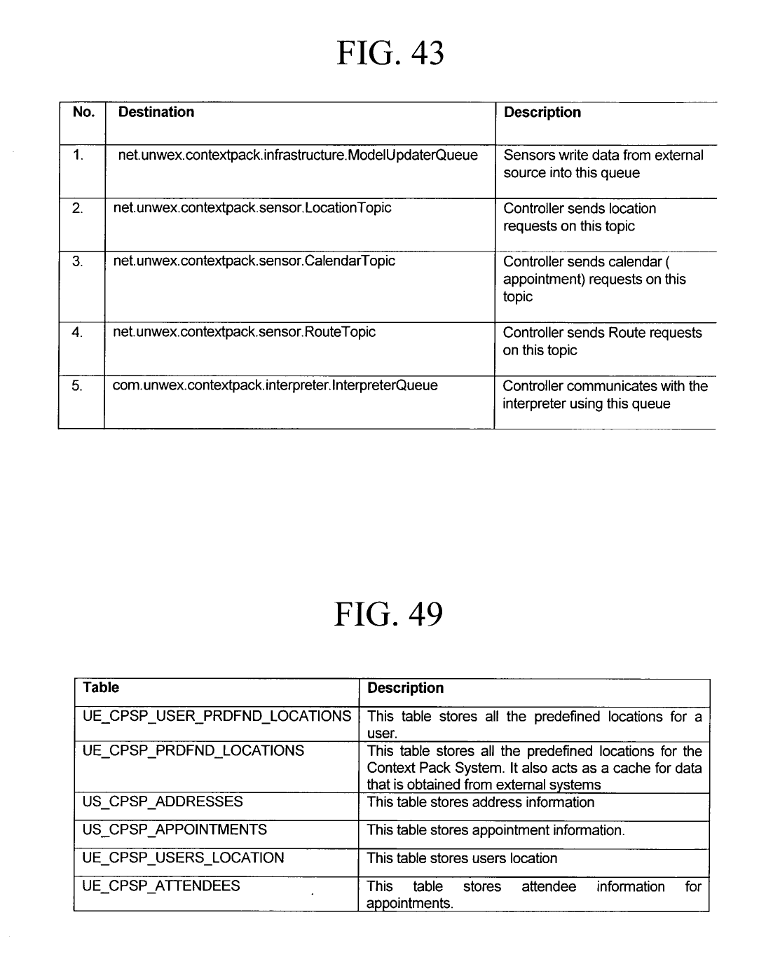

In an embodiment of the present invention, the Messaging System (Data Bus) is a JMS based system. The Messaging System acts as the conduit for data transfer between the sensors and interpreters to the Context Pack data model. The asynchronous nature of the messaging system allows the Context Pack to manage data handling without blocking or slowing down the clients that generate the data. The messaging system of an embodiment of the present invention includes the Topics and Queues shown in the table contained in FIG. 43.

In an embodiment of the present invention, a spatial service provides spatial functions, which allow efficient storage of location information, and provides useful APIs to perform proximity and other spatial operations.

In an embodiment of the present invention, a geocoding service provides conversion of position (e.g., latitude, longitude) location data to one or more addresses, and vice versa.

FIG. 44 presents a diagram of an example Context model used in a Context Pack, in accordance with an embodiment of the present invention. The context model is the representation of the context pack data on the Context Server. The state model describes the hierarchy of the states used in the context model.

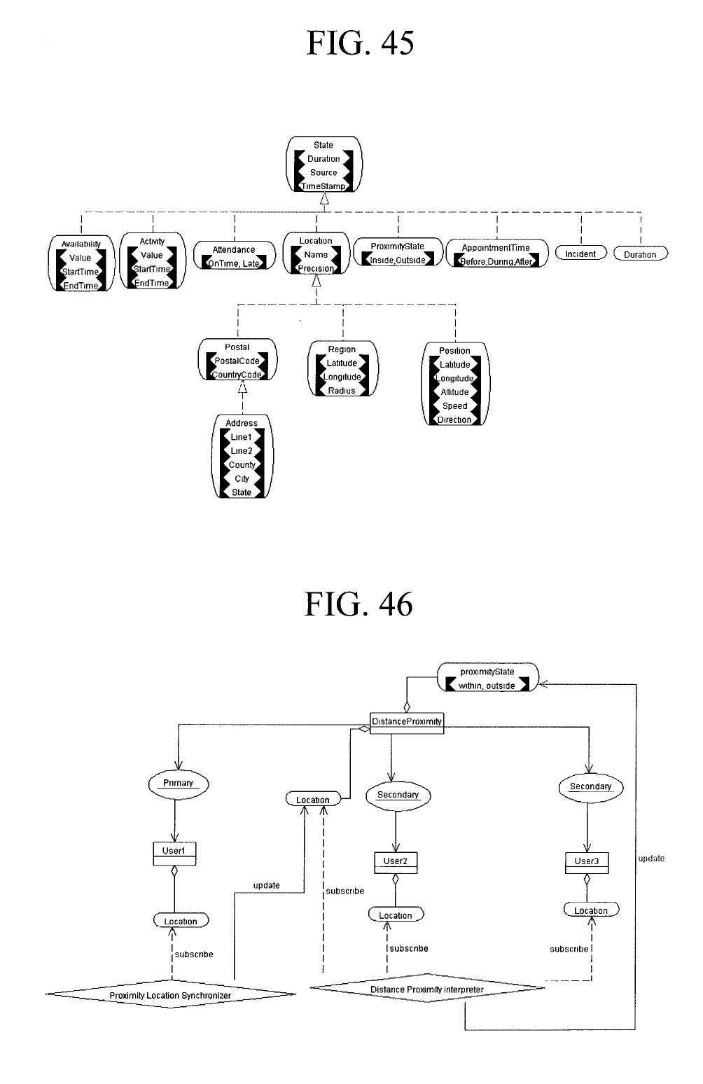

FIG. 45 is a representative block diagram of a state model for use in accordance with an embodiment of the present invention.

FIG. 46 contains a flow diagram of an example distance proximity event, in accordance with an embodiment of the present invention. The example of FIG. 46 shows how the proximity of 5 miles for the separation of user1, user2, and user3 is handled.

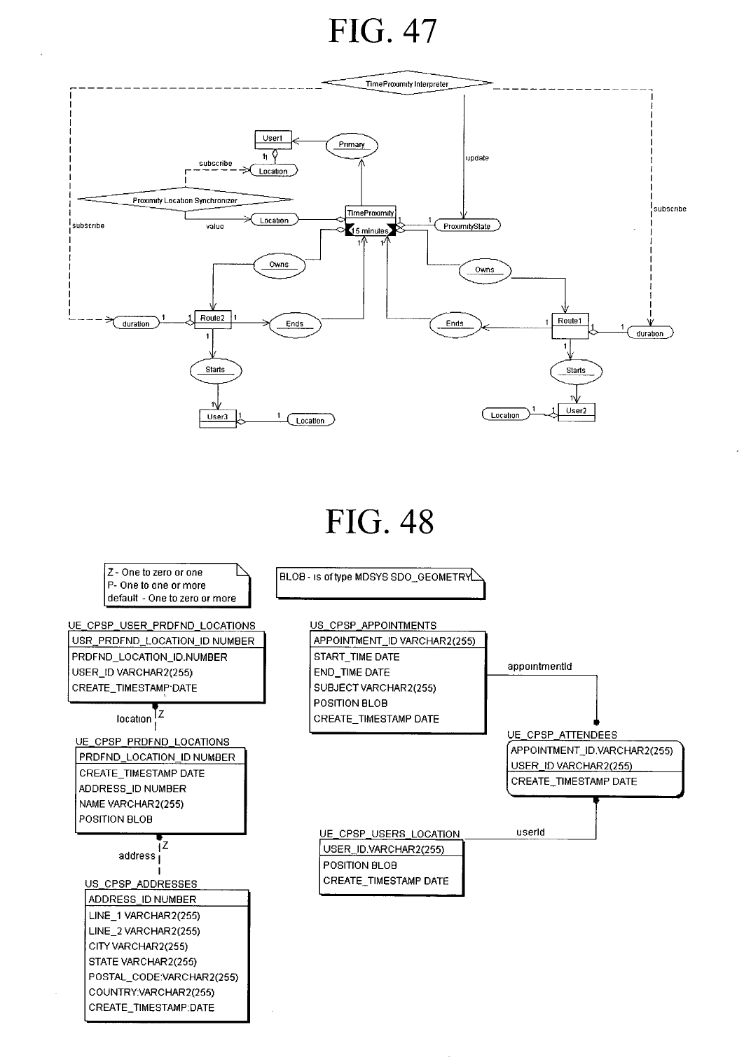

FIG. 47 presents a flow diagram of an example time proximity event, in accordance with an embodiment of the present invention. The example of FIG. 47 shows how the proximity of 15 minutes for the separation of user1, user2, and user3 is handled.

FIG. 48 is a representative ER diagram showing the database or other repository schema for an example Context Pack, in accordance with an embodiment of the present invention. FIG. 49 shows a table of information for use in conjunction with the database schema of FIG. 48.

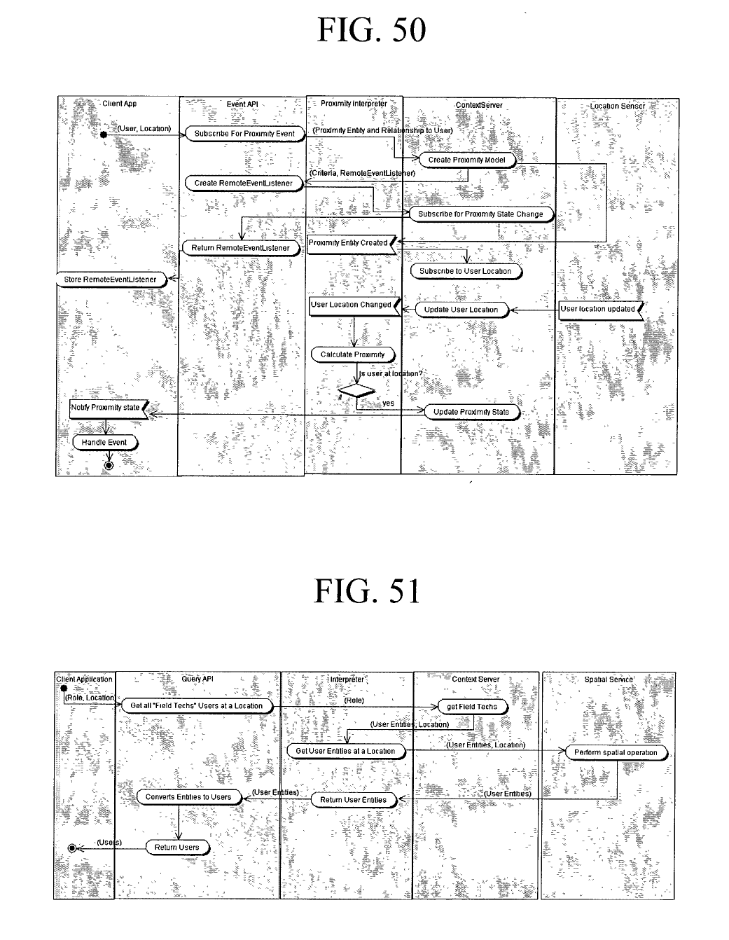

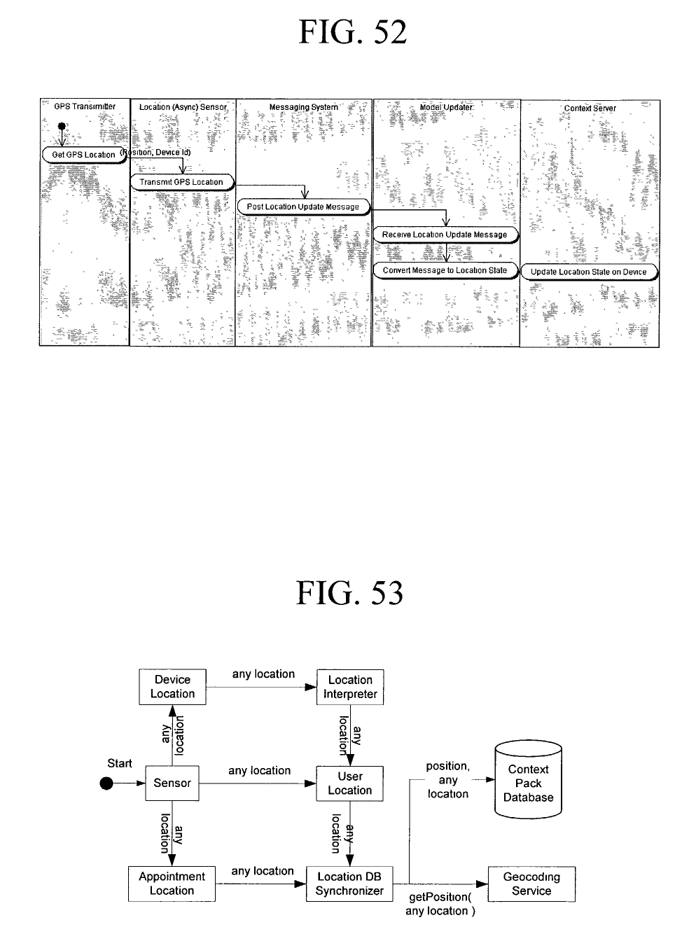

FIGS. 50-52 present flow diagrams of example context events, in accordance with embodiments of the present invention. FIG. 50 is an example user proximity event activity, in accordance with an embodiment of the present invention. FIG. 51 shows an example group proximity query, in accordance with an embodiment of the present invention. FIG. 52 contains an example user location updating activity, in accordance with an embodiment of the present invention.

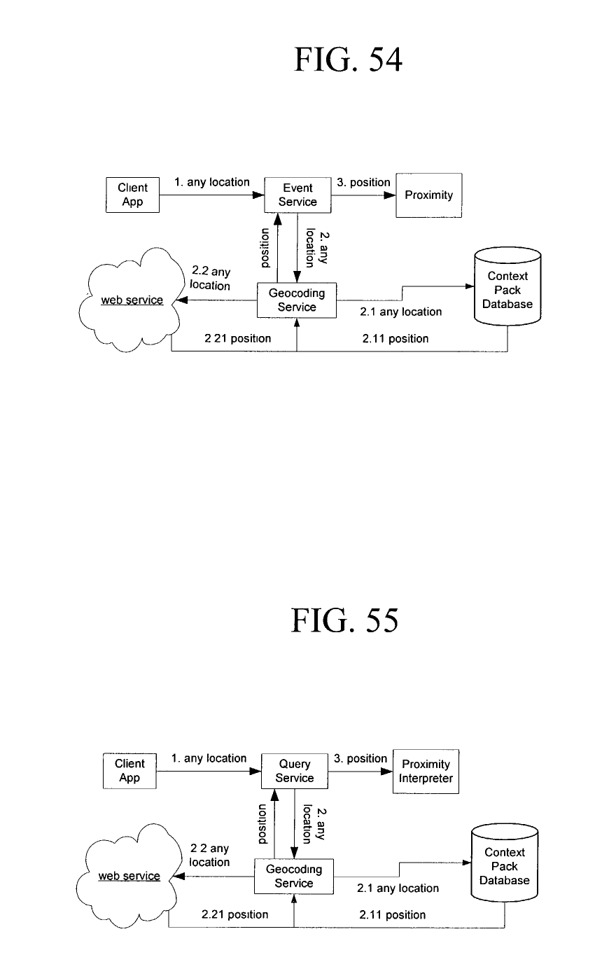

FIGS. 53-54 present flow diagrams of example rule applications for location events, in accordance with embodiments of the present invention. FIG. 53 is an example flow diagram for handling of sensor specified location in the Context Pack, in accordance with an embodiment of the present invention. FIG. 54 shows an example flow diagram for location handling in the event service, in accordance with an embodiment of the present invention. FIG. 55 contains an example flow diagram for location handling in the query service, in accordance with an embodiment of the present invention.

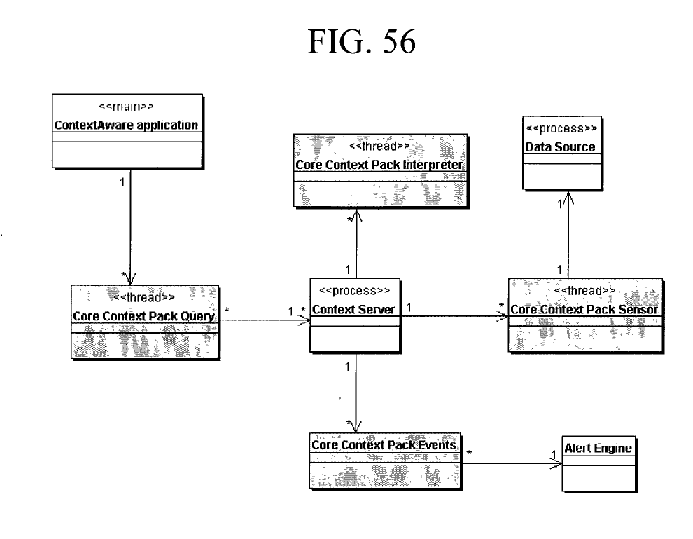

FIG. 56 is a representative block diagram of a runtime view, including processes, threads, and remote objects, in accordance with an embodiment of the present invention.

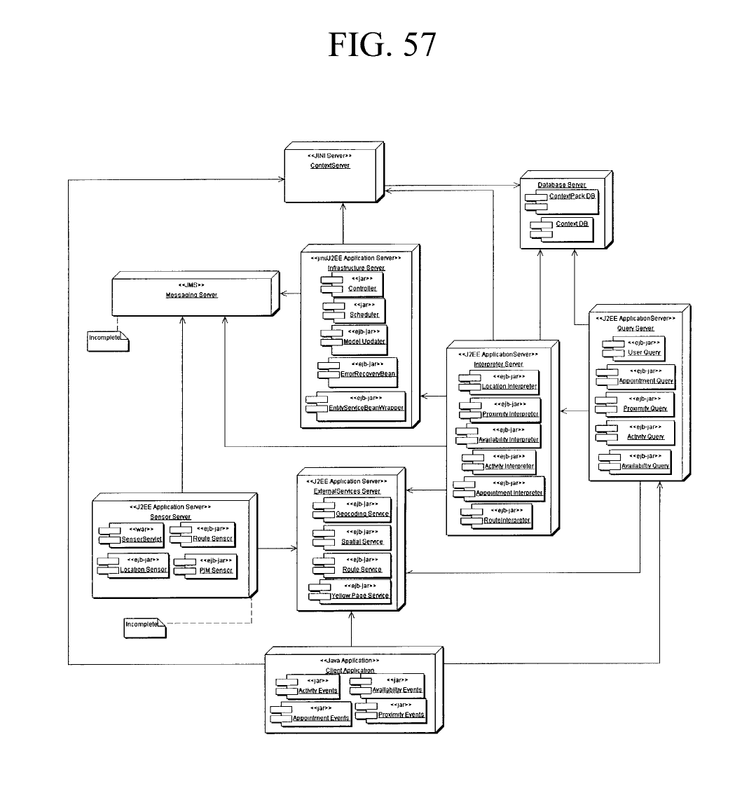

FIG. 57 presents a representative flow diagram of a deployment view, including JVM nodes for a distributed objects model, a distributed objects model, and mapping of development jars to deployment jars, in accordance with an embodiment of the present invention.

The Context Pack can be deployed in many different ways, as it confirms to the J2EE 1.2 specification. The diagram shown in FIG. 57 displays one of the configurations. A simple configuration would be to bundle all the Enterprise Java Beans into one ear file and deploy it to a J2EE server. A cluster of J2EE Servers can provide Load Balancing and fail over.

It is thus clear that, in embodiments of the present invention, the architecture provides a clean interface to the user to query and subscribe to contextual data. Among other advantages, the architecture hides the developer from the underlying complexities of understanding context and presents the information in a simple data format. Extension points are provided so that developers can add new interpreters as needed, and sensors are completely isolated from the system.

In one embodiment of the present invention, the architecture uses the well-defined and popular J2EE framework. This provides a familiar and well-known technology as the basis for Context Aware application development. As the code conforms to J2EE 1.2 specifications, Context Aware applications can be developed and deployed on any of the many application servers that confirm to the J2EE 1.2 specification.

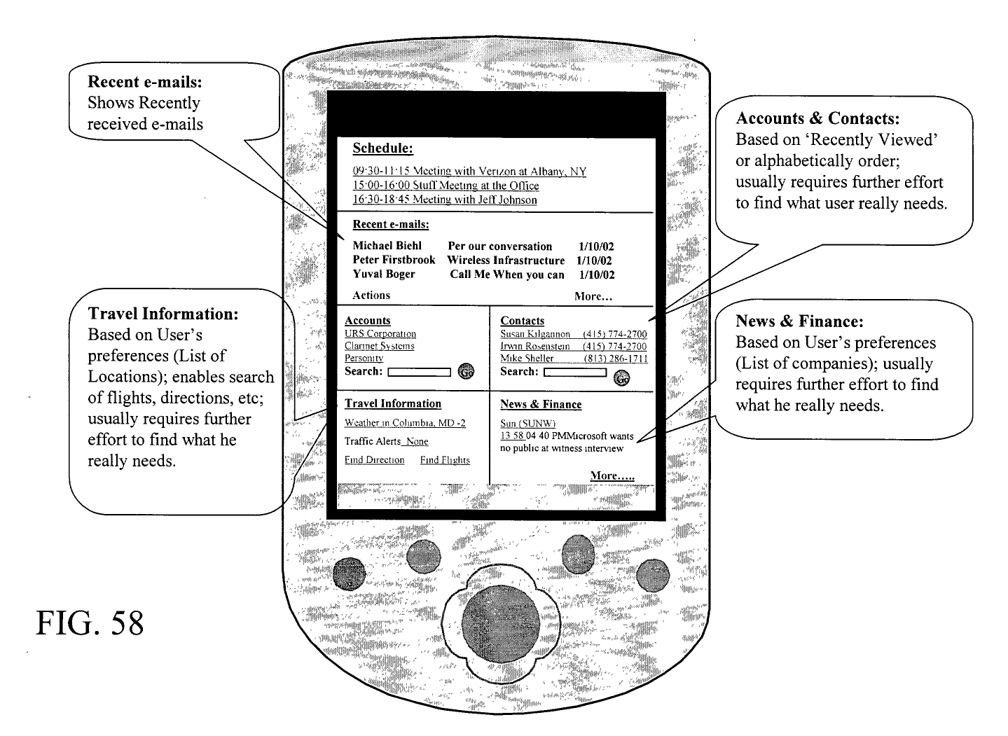

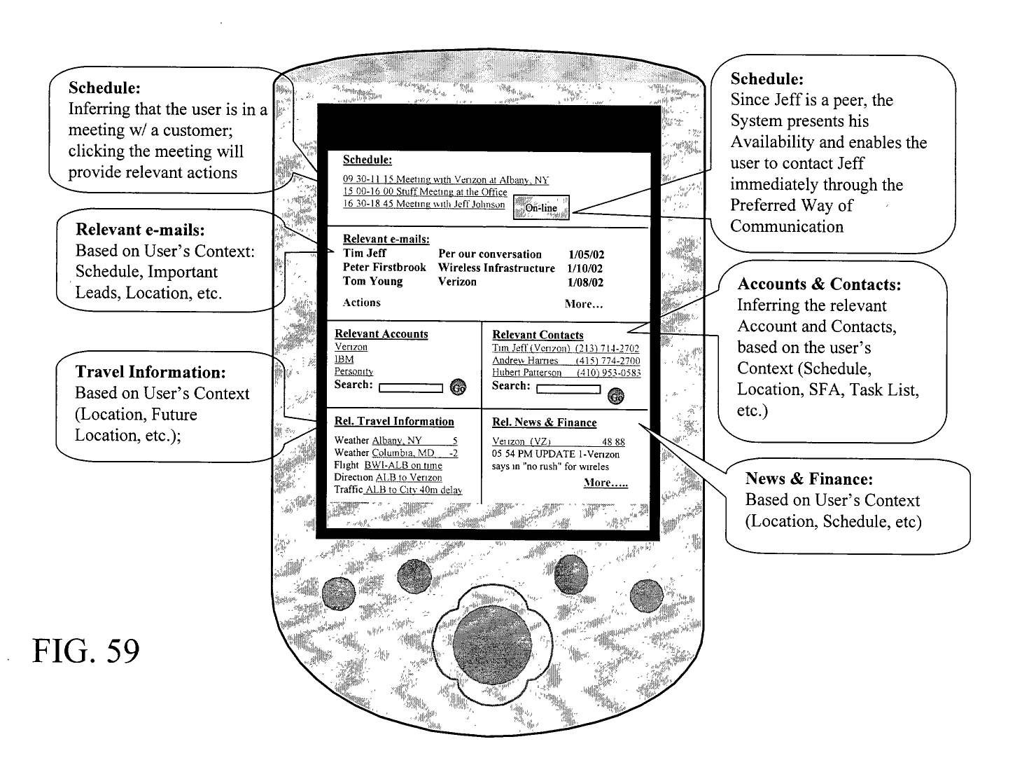

FIGS. 58 and 59 present context based information examples for a hand held device, in accordance with an embodiment of the present invention. In particular, in the example shown in FIGS. 58 and 59, a comparison is presented between a portal (FIG. 58) and a portal leveraging context information to determine relevant information for the user (FIG. 59).

Example embodiments of the present invention have now been described in accordance with the above advantages. It will be appreciated that these examples are merely illustrative of the invention. Many variations and modifications will be apparent to those skilled in the art.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for providing context-relevant information, comprising:
collecting context specific information;
determining information needs relating to the context specific information collected; and
providing delivery information to a platform, wherein the delivery information is formatted based on the platform, the collected context specific information, and the determined information needs.

2. The method of claim 1, wherein the platform includes an application interface.

3. The method of claim 1, wherein the platform includes a platform device.

4. The method of claim 3, wherein the platform device is selected from a group consisting of a personal computer, a minicomputer, a microcomputer, a main frame computer, a personal digital assistant, a mobile telephone, a cellular telephone, and a pager.

5. The method of claim 3, wherein the platform device comprises a handheld device.

6. The method of claim 1, wherein the context specific information includes information for a user.

7. The method of claim 1, wherein the context specific information includes information for a device.

8. The method of claim 1, wherein the context specific information includes at least one selected from a group consisting of location information, personal information manager information, presence information, travel information, device usage information, network information, workgroup information, role information, skill information, application information, user settings information, device settings information, and web services information.

9. The method of claim 1, wherein the context specific information is collected from an information source.

10. The method of claim 1, wherein the context specific information is collected for context parameters.

11. The method of claim 10, wherein the context parameters include implicit context parameters and explicit context parameters.

12. The method of claim 8, wherein the location information is selected from a group consisting of carrier based information, geographical positioning system information, Wifi information, Bluetooth information, and services information.

13. The method of claim 8, wherein the personal information manager information is selected from a group consisting of applications information and services information.

14. The method of claim 8, wherein the presence information is selected from a group consisting of applications information and services information.

15. The method of claim 8, wherein the travel information is selected from a group consisting of proximity information, direction information, flight information, weather information, and traffic information.

16. The method of claim 1, wherein determining information needs relating to the context specific information collected includes:
determining a user's situation and intent.

17. The method of claim 1, wherein determining information needs relating to the context specific information collected includes:
determining a device situation.

18. The method of claim 16, wherein the user's situation and intent are obtained from analysis information.

19. The method of claim 18, wherein the analysis information includes relevant information.

20. The method of claim 19, wherein the relevant information is selected from a group consisting of relevant information, relevant actions, and relevant method of delivery information.

21. The method of claim 19, wherein the relevant information is identified from available information.

22. The method of claim 21, wherein the relevant information is identified from static context.

23. The method of claim 21, wherein the relevant information is identified from dynamic context.

24. The method of claim 21, wherein the relevant information is identified from preference information.

25. The method of claim 24, wherein the preference information includes historic behavior information.

26. The method of claim 21, wherein the relevant information is determined using user situation information.

27. The method of claim 21, wherein the relevant information is determined using device situation information.

28. The method of claim 21, wherein the relevant information is determined using user intent information.

29. The method of claim 18, wherein the analysis information includes analyzed location information, event status information, availability information, device information, activity information, application information, and proximity information.

30. The method of claim 1, wherein the delivery information includes at least one selected from a group consisting of automatically entered data, voice information, navigation information, and presentation information.

31. The method of claim 1, wherein providing delivery information to a platform includes:
providing an alert.

32. The method of claim 1, wherein collecting context specific information includes:
obtaining information from a plurality of applications.

33. The method of claim 32, wherein each of the plurality of applications includes a relevant application portion for the delivery information, and wherein providing delivery information to a platform includes:
providing a consolidated interface, the consolidated interface including the relevant application portion for each of the plurality of applications.

34. The method of claim 33, wherein the consolidated interface is formatted for the platform.

35. The method of claim 1, wherein providing delivery information to a platform includes:
synchronizing information for the platform.

36. The method of claim 1, wherein providing delivery information to a platform includes:
providing a menu of options.

37. The method of claim 1, wherein providing delivery information to a platform includes:
providing smart network services.

38. The method of claim 1, further comprising:
providing context and system services.

39. The method of claim 38, wherein the context and system services include at least one selected from a group consisting of administration services, security services, privacy services, user preferences, logical location repository services, context history services, new context discovery services, radius proximity services, positioning services, and geocoding services.

40. A method for providing context-relevant information, the method comprising:
obtaining links to information for a plurality of entities;
identifying states for the plurality of entities;
identifying relationships among the plurality of entities;
receiving predetermined criteria for providing information relating to the entities; and
delivering context-relevant information to at least one platform, wherein the context-relevant information is determined based on the predetermined criteria, the states of the entities, and the relationship among the entities.

41. The method of claim 40, further comprising:
identifying states for the relationships.

42. The method of claim 41, wherein obtaining links to information includes:
interfacing with at least one sensor.

43. The method of claim 42, wherein the information is received from the at least one sensor, and wherein obtaining links to information includes:
applying interpreters to the information received from the at least one sensor.

44. The method of claim 43, wherein the information is received from the interpreters.

45. The method of claim 40, wherein the plurality of entities are selected from a predetermined set of entities.

46. The method of claim 40, wherein the states for the plurality of entities are selected from a predetermined set of states.

47. The method of claim 40, wherein the relationships among the plurality of entities are selected from a predetermined set of relationships.

48. A system for providing context-relevant information, comprising:
at least one network;
a delivery platform coupled to each of the at least one network;
a server; and
at least one context data source coupled to the server;
wherein the server collects context parameters from the at least one context data source;
wherein the server includes a context engine for analyzing the collected context parameters; and
wherein the server provides context actions/effects using the collected and analyzed context parameters.

49. The system of claim 48, wherein the at least one network includes the Internet.

50. The system of claim 48, wherein the at least one network includes a cellular telephone network.

51. The system of claim 48, wherein the delivery platform is selected from a group consisting of a personal computer, a minicomputer, a microcomputer, a main frame computer, a personal digital assistant, a mobile telephone, a cellular telephone, and a pager.

52. A system for providing context-relevant information, comprising:
means for collecting context specific information;
means for determining information needs relating to the context specific information collected; and
means for providing delivery information to a platform, wherein the delivery information is formatted based on the platform, the collected context specific information, and the determined information needs.
